(19) United States
(12) Patent Application Publication
(10) Pub. No.: US 2006/0198336 A1
(43) Pub. Date: Sep. 7, 2006

(54) Deployment of different physical layer protocols in a radio access network

(75) Inventors: Tamas Major, Dusseldorf (DE); Torsten Musiol, Ratingen (DE); Pekka Karppinen, Helsinki (FI); Hannu Hakkinen, Espoo (FI); Hannu Vaitovirta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/175,345

(22) Filed: Jul. 7, 2005

(30) Foreign Application Priority Data
Mar. 3, 2005 (EP) 05 004 646.5

(51) Int. Cl. H04Q 7/00; H04Q 7/24; H04J 3/16; H04J 3/22

(52) U.S. Cl. 370/328; 370/338; 370/469

(57) ABSTRACT

This invention relates to a method, a system, a base station, a base station hub (41) and software applications for data transmission between at least one base station (42-1, 42-2) and a radio network controller (40) in a radio access network, said method comprising operating a first-type physical layer protocol (46) for a transmission of said data between said at least one base station (42-1, 42-2) and a base station hub (41); operating a second-type physical layer protocol (47) for a transmission of said data between said base station hub (41) and said radio network controller (40); wherein said data comprises user data (340) that is transmitted between said radio network controller (40) and said at least one base station (42-1, 42-2) via said base station hub (41); and wherein said at least one base station (42-1, 42-2) performs at least base band processing for signals that are transmitted via a radio interface (7) and represent said user data (340).

### FIELD OF THE INVENTION

This invention relates to a method, a system, a base station, a base station hub and software applications for data transmission between at least one base station and a radio network controller in a radio access network.

### BACKGROUND OF THE INVENTION

The Universal Mobile Telecommunications System (UMTS) is a third-generation broadband wireless transmission system for text, digitized voice, video, and multimedia at data rates up to 2 megabits per second that offers a consistent set of services to mobile computer and phone users.

The network elements of a UMTS 1 are illustrated in FIG. 1. The network elements are functionally grouped into the radio access network (UMTS Terrestrial Radio Access Network, UTRAN) 11 that handles all radio-related functionality, and the Core Network (CN) 12, which is responsible for switching and routing calls and data connections to external networks 2, for instance circuit-switched networks 20 such as PSTN and ISDN, and packet-switched networks 21 as for instance the Internet. To complete system 1, the User Equipment (UE) 10 that interfaces with the user and the radio (Uu) interface 15 is defined.

The UTRAN 11 consists of one or more Radio Network Sub-systems (RNS) 110. An RNS 110 is a sub-network within the UTRAN 11 and consists of one Radio Network Controller (RNC) 1101 and one or more Node Bs 1100 (also denoted as base station throughout this patent specification).

The Node B 1100 converts the data flow between the Iub 16 and Uu 15 interfaces. The main function of the Node B 1100 is to perform the radio interface physical layer processing (channel coding and interleaving, rate adaptation, spreading, etc.). It also performs some basic radio resource management operation as for instance the inner loop power control.

The Radio Network Controller (RNC) 1101 owns and controls the radio resources in its domain, i.e. the Node Bs 1100 connected to it. The RNC 1101 is the service access point for all services the UTRAN 11 provides to the CN 12, for example management of connections to the UE 10.

Protocol structures in the UTRAN interfaces, e.g. the Iub interface 16, are designed according to a general protocol model. This model is defined in technical specification 3GPP TS 25.401 version 6.4.0 Release 6 and is depicted in FIG. 2.

The protocol model 3 in FIG. 2 consists of two main horizontal layers, the radio network layer 30, and the transport network layer 31. All UTRAN-related issues are visible only in the radio network layer 30, and the transport network layer 31 represents standard transport technology that is selected to be used for UTRAN, but without any UTRAN-specific requirements.

The protocol model 3 in FIG. 2 further consists of 3 vertical planes, the radio network control plane 32, the transport network control plane 33 and the user plane 34.

The radio network control plane 32 includes the application protocol 320, i.e. the Radio Access Network Application Part (RANAP), Radio Network Sub-system Application Part (RNSAP) or Node B Application Part (NBAP) protocol, and the signalling bearer 321 for transporting the application protocol messages. Among other things, the application protocol 320 is used for setting up bearers (i.e. radio access bearers or radio links) in the radio network layer 30. In the three-plane structure of FIG. 2, the bearer parameters in the application protocol 320 are not directly tied to the user plane 34 technology, but are rather general bearer parameters. The signalling bearer 321 for the application protocol 320 may or may not be of the same type as the signalling bearer 331 for the Access Link Control Application Protocol (ALCAP) 330 (see transport network user plane 33). The signalling bearer 321 is always set up by Operation and Maintenance (O&M) actions.

The user plane 34 includes the one or more data streams 340 and the one or more data bearers 341 for the data streams 340. The data streams 340 are characterised by one or more Frame Protocols (FP) specified for that interface.

The transport network control plane 33 does not include any radio network layer 30 information, and is completely in the transport layer 31. It includes the ALCAP protocol 330 that is needed to set up the data bearers 341 (also denoted as transport bearers) for the user plane 34. It also includes the appropriate signalling bearers 331 needed for the ALCAP protocol 330. The transport network control plane 33 is a plane that acts between the radio network control plane 32 and the user plane 34. The introduction of the transport network control plane 33 is performed in a way that the application protocol 320 in the radio network control plane 32 is kept mainly independent of the technology selected for data bearers 341 in the user plane 34. Indeed, the decision to actually use an ALCAP protocol 330 is completely kept within the transport network layer 31.

It should be noted that ALCAP 330 might not be used for all types of data bearers 341. If there is no ALCAP signalling transaction, the transport network control plane 33 is not needed at all. This is the case when pre-configured data bearers 341 are used or when the Internet Protocol (IP) UTRAN option is used between two IP UTRAN nodes or between an IP UTRAN node and an IP CN node.

When the transport network control plane 33 is used, the transport bearers for the data bearer 341 in the user plane 34 are set up in the following fashion. First there is a signalling transaction by the application protocol 320 in the radio network control plane 32, which triggers the set up of the data bearer 341 by the ALCAP protocol 330 that is specific for the user plane 34 technology.

The data bearers 341 in the user plane 34, and the signalling bearers 321 for the application protocol 320 belong also to a transport network user plane 35. As already stated, the data bearers 341 in the transport network user plane 35 are directly controlled by the transport network control plane 33 during real-time operation, but the control actions required for setting up the signalling bearers 321 for the application protocol 320 are considered O&M actions.

The signalling bearer 321 and 331 and the data bearer 341 use the services of the same physical layer protocol 310, which is part of the transport network layer 31.

Technical specification 3GPP TS 25.430 version 6.2.0 Release 6 defines the protocol structure of the UTRAN Iub interface in more detail. This protocol structure 3′ is depicted in FIG. 3, wherein the used reference signs correspond to the reference signs of the protocol structure 3 in FIG. 2.

In the Iub-specific protocol structure 3′ of FIG. 3, the radio network layer 30 defines procedures related to the operation of Node B. The transport network layer 31 defines procedures for establishing physical connections between Node B and RNC.

In the protocol structure 3′, the Node B Application Part (NBAP) 320 is used as application protocol, and a plurality of different UMTS Channels (CH), for instance a Dedicated Channel (DCH) or a Random Access Channel (RACH), the data of which is segmented into Frame Protocol (FP) frames, represent the data streams 340 of FIG. 2. The Q.2630.2 protocol 330 represents the ALCAP protocol in the transport network user plane 33, which uses a signalling bearer 331 that is implemented by an ATM-based protocol architecture.

As can be readily seen from the protocol structure 3′ of FIG. 3, both the signalling bearer 321 in the radio network control plane 32 and the data bearers 341 in the user plane 34 can be implemented either by an Asynchronous Transfer Mode (ATM)-based protocol architecture or an Internet Protocol (IP)-based protocol architecture. In particular, in the user plane 34, the FP frames 340 then are either transported via an ATM Adaptation Layer 2 (AAL2) protocol on top of an ATM protocol, or via a User Datagram Protocol (UDP) on top of an IP protocol (which in turn uses the services of a data link layer protocol). Therein, as it is the case with the protocol structure 3 in FIG. 2, all protocol architectures 321, 331 and 341 use the services of the same physical layer protocol 310.

The protocol structure 3′ of FIG. 3 offers operators the possibility to use either ATM- or IP-based signalling bearers 321 and data bearers 341 on the Iub interface 16 (see FIG. 1) of the UTRAN 11.

Prior art document WO 01/91399 proposes an interworking function that is situated on a transport interface between two nodes of a radio access network and interworks different transport technologies in the user plane (for instance ATM- and IP-based data bearers). Therein, said nodes may for instance be a Node B and an RNC of an UTRAN, and said transport interface may be located in an interworking node between the Node B and the RNC. It is then possible to operate a Node B that uses a first transport technology (for instance an ATM-based data bearer) and an RNC that uses a second transport technology (for instance an IP-based data bearer). Prior art document WO 01/91399 however assumes the use of the same physical layer protocol on both sides of the interworking node.

Among the physical layer protocols defined for the Iub interface 16 of the UTRAN 11 (see FIG. 1) in technical specification 3GPP TS 25.411 version 6.1.0 Release 6, the most frequently used physical layer protocols are Time Division Multiplex (TDM) links like Synchronous or Plesiochronous Digital Hierarchy (SDH/PDH) transmission links, for instance E1 or T1, which have a capacity of 2 Mbit/s and 1.5 Mbit/s, respectively.

If more transmission capacity is needed, then multiple of those links will be aggregated by Inverse Multiplexing for ATM (IMA). However, with increasing numbers of transmission links (and correspondingly increasing numbers of cables and interfaces), the management complexity increases, and furthermore, compatibility problems may arise due to increasing ATM and IMA complexity.

The same problem is encountered in the context of a distributed base station architecture, as for instance specified by the Open Base Station Architecture Initiative (OBSAI) or the Common Public Radio Interface (CPRI). For instance, in the architecture specified by OBSAI, a base station is split into two parts: a base station head, which contains the Radio Frequency (RF) transceivers and amplifiers and performs the conversion of signals between RF and digital base band, and a base station body, which comprises a processing module and a transport module. Therein, said processing module contains channel modems and performs base band processing for the radio interface, and said transport module performs an adaptation of signals between external interfaces like the Iub interface of the UTRAN and an internal base station (body) interface. Because on said Iub interface, again SDH/PDH links are most frequently used as transmission links, the same problems of increasing management complexity and potential incompatibility with increasing transmission capacity is encountered as in the case where a non-distributed base station is used. Furthermore, due to the high data rate on the interface between the base station head and the base station body of a distributed base station, which is caused by the fact that the base band processing is performed in the base station body, a fibre connection may have to be used for this interface. The fibre cable has to be installed by the operator, which vastly increases the deployment costs.

### SUMMARY OF THE INVENTION

In view of the above-mentioned problems, it is, inter alia, an object of the present invention to provide an improved method, system, base station, base station hub and improved software applications for a data transmission between at least one base station and a radio network controller in a radio access network.

It is proposed a method for data transmission between at least one base station and a radio network controller in a radio access network, said method comprising operating a first-type physical layer protocol for a transmission of said data between said at least one base station and a base station hub; operating a second-type physical layer protocol for a transmission of said data between said base station hub and said radio network controller; wherein said data comprises user data that is transmitted between said radio network controller and said at least one base station via said base station hub; and wherein said at least one base station performs at least base band processing for signals that are transmitted via a radio interface and represent said user data.

Said radio network controller, said base station hub and said at least one base station may represent a part of said radio access network. Said radio network controller controls said at least one base station to establish connections between mobile stations and a core network of a mobile radio communications system. To this end, data is transmitted between said radio network controller and said at least one base station, wherein said data comprises user data, which is transmitted between said radio network controller and a mobile station via said base station (and between said base station and said mobile station via said radio interface), and wherein said data may further comprise control data transmitted between said radio network controller and said at least one base station, for instance control data related to the set-up of data bearers for the transmission of said user data within said radio access network. Said user data may for instance represent data streams in a user plane of a UTRAN.

According to the present invention, said data is not transmitted directly between said radio network controller and said at least one base station, but via a base station hub, and on a link between said at least one base station and said base station hub, a different physical layer protocol is used as on a link between said base station hub and said radio network controller. Therein, a physical layer protocol is understood to represent the transmission medium and/or the bit transmission protocol used on said transmission medium. The physical layer protocol is operated by implementing physical layer protocol entities in both nodes that terminate said physical layer protocol. In the simplest case, such physical layer protocol entities may be interfaces of a transmission medium. Said first-type physical layer protocol may for instance represent an Ethernet network, and said second-type physical layer protocol may for instance represent a Synchronous or Plesiochronous Digital Hierarchy link. Said base station hub has to provide at least interfaces for said first-type and second-type physical layer protocols. Said base station hub may further provide an interworking of said first-type and second-type physical layer protocols on the physical layer level, but interworking in said base station hub may equally well be performed in protocol layers above the physical layer. The feature that said at least one base station at least provides base band processing for signals that are transmitted via said radio interface, for instance equalization, spreading/de-spreading, scrambling/de-scrambling, channel estimation or further base band processing techniques, clearly differentiates said at least one base station and base station hub according to the present invention from prior art base station heads and base station bodies of distributed base station architectures, respectively.

The introduction of the base station hub according to the present invention allows for the use of at least two different physical layer protocols between said radio network controller and said base station and thus increases the degrees of freedom in choosing appropriate and efficient transmission technologies for the operator. For instance, an operator may choose to use Ethernet as first-type physical layer protocol between said base station and said base station hub instead of the SDH/PDH links commonly used in radio access networks, which vastly contributes to reduce the cabling costs, in particular if already installed Ethernet infrastructure networks can be re-used. The use of different physical layer protocols between radio network controller and base station hub on the one hand and base station hub and base station on the other hand also allows to shift complex transmission- and transport-related functionality from the base station into the base station hub, so that the base stations according to the present invention become less complex, cheaper and smaller, and so that functionality is more efficiently used in the base station hub.

Said base station hub may be located in said radio network controller, or in said base station, or may represent a separate node between said radio network controller and said base station.

According to an embodiment of the present invention, said data further comprises control data that is transmitted between said at least one base station and said radio network controller via said base station hub to perform control signalling in at least one of a radio network layer and a transport network layer of said radio access network. Therein, said radio network layer may be related to procedures for the operation of said base station, and said transport network layer may be related to procedures for establishing physical connections between said base station and said radio network controller. If said radio access network is an UTRAN, said control data may for instance be messages of the ALCAP and NBAP protocol.

According to an embodiment of the present invention, said data further comprises management data related to a management of said at least one base station. Said management of said at least one base station may for instance at least partially be related to Fault, Configuration, Accounting, Performance and Security Management (FCAPS), and/or implementation-specific aspects (hardware and software of the base station). Therein, configuration may also include setting of transport network layer connections. These management operations may typically be performed by a management system. Said management data from said management system may nevertheless be routed via said radio network controller.

According to an embodiment of the present invention, said first-type physical layer protocol is an IEEE 802 physical layer protocol. The project 802 of the IEEE defines a plurality of wire-bound and wireless physical layer protocols, which are known as IEEE 802 physical layer protocols. These protocols are considered as layer-1 protocols in the International Standardization Organisation (ISO) Open Systems Interconnection (OSI) reference model for the connection of open systems. Examples of IEEE 802 physical layer protocols are 802.3 (Ethernet), 802.11 (Wireless Local Area Network, WLAN) and 802.16 (WiMAX). Correspondingly, according to the present invention, a plurality of physical layer protocols and associated network technologies can be deployed for the link between said at least one base station and said base station hub.

According to an embodiment of the present invention, said first-type physical layer protocol is an IEEE 802.3 physical layer protocol. Said IEEE 802.3 physical layer protocol represents an Ethernet network, which is a widely used data communications network standard developed by DEC, Intel and Xerox.

The use of an Ethernet network for data transmission between the base station and the base station hub may be particularly advantageous because existing Ethernet cables and networks, for instance in-house infrastructure of a Local Area Network (LAN), may be easily reused. The use of Ethernet may allow to reduce the size of said base station, because an explicit transport block housing interfaces for the PDH or SDH links that are frequently used in prior art for the link between the radio network controller and the base station is no longer required. Ethernet provides support for data rates of 10, 100, 1000 and 10000 Mbit/s that are all easily interoperable.

According to an embodiment of the present invention, said second-type physical layer protocol represents one of a Synchronous or a Plesiochronous Digital Hierarchy link. Said links may for instance be E1 or T1 links with a capacity of 2 Mbit/s or 1.5 Mbit/s, respectively, or any other type of SDH/PDH link.

According to an embodiment of the present invention, said radio access network is a Universal Mobile Telecommunications System Terrestrial Radio Access Network. Then said base station and said base station hub together may form a legacy Node B according to the UMTS standard, and said second-type physical layer protocol can be chosen for the Iub interface between the radio network controller and the Node B without violating the UMTS standard. The first-type physical layer protocol then may for instance be considered as a Node B internal interface.

According to an embodiment of the present invention, said data is transmitted between a plurality of base stations and said radio network controller, and said base station hub operates said first-type physical layer protocol for a transmission of said data between said base station hub and said plurality of base stations. Said plurality of base stations may for instance be connected to the base station hub via an Ethernet network. When several base stations are connected to said base station hub, said base station hub may concentrate functionality that in prior art is provided by said base stations, so that the complexity of said base stations may be reduced. Said functionality may refer to both hardware and software of said base stations. For instance, said base station hub may terminate management protocols towards the radio network controller and use a proprietary management protocol for the management of its associated base stations. For the radio network controller, the base station hub with its associated base station then may appear as a single base station.

According to an embodiment of the present invention, said base station hub provides synchronization information to said at least one base station. Said synchronization information may be required by said at least one base station to run its radio interface properly. Said base station hub itself may derive said synchronization information from said second-type physical layer protocol, for instance the SDH/PDH link, or via network-external sources, as for instance the Global Positioning System (GPS)

### First Aspect of the Invention

According to an embodiment of a first aspect of the present invention, said method further comprises interworking said second-type physical layer protocol and a first protocol, which is operated between said base station hub and said at least one base station for a transmission of said data on top of said first-type physical layer protocol, in said base station hub while not terminating a second protocol that is operated between said at least one base station and said radio network controller for a transmission of said data on top of said second-type physical layer protocol and said first protocol.

In this context, a protocol operated between two nodes of a network is understood to be not terminated by an intermediate node if it is operated end-to-end between said two nodes irrespective of potential conversions of lower-layer protocols in said intermediate node. According to this first aspect of the present invention, with respect to said second-type physical layer protocol, said base station hub acts as a physical layer protocol converter that does not terminate said second protocol that is operated between said at least one base station and said radio network controller. Complexity of said base station hub, which then represents a media converter, can then be kept minimum.

On top of said second protocol, a third protocol for a transmission of said user data between said at least one base station and said radio network controller may be operated. Said user data may for instance represent data streams in the user plane of a UTRAN. Said third protocol may for instance be an ATM Adaptation Layer Type 2 (AAL2) protocol. The AAL2 protocol provides bandwidth-efficient transmission of low-rate, short and variable packets in delay sensitive applications. It supports variable and constant bit rates. AAL2 also provides for variable payload within cells and across cells. AAL2 is subdivided into the Common Part Sublayer (CPS) and the Service Specific Convergence Sublayer (SSCS).

Said data may further comprise control data that is transmitted between said at least one base station and said radio network controller via said base station hub to perform control signalling in said radio access network, and then a third protocol for a transmission of said control data between said at least one base station and said radio network controller may be operated on top of said second protocol. Said control data may for instance represent ALCAP or NBAP protocol data units, and said third protocol then may refer to a protocol architecture in the transport network control plane and the radio network control plane of a UTRAN, respectively. Said third protocol then may for instance be an ATM Adaptation Layer Type 5 (AAL5) protocol. The AAL5 protocol provides point-to-point and point-to-multipoint (ATM layer) connections. AAL5 may for instance be used to carry Internet Protocol (IP) data.

According to an embodiment of the first aspect of the present invention, said first-type physical layer protocol is an IEEE 802 physical layer protocol, said second-type physical layer protocol represents one of a Synchronous and a Plesiochronous Digital Hierarchy link, and said first protocol is an IEEE 802 MAC protocol. Therein, said IEEE 802 MAC protocol represents the Medium Access Control (MAC) protocol for the IEEE 802 physical layer protocol. Said SDH or PDH link is interworked with said IEEE 802 MAC protocol to allow for a transmission of data between said base station and said radio network controller via said base station hub. This interworking may be based on a mapping table. Said second protocol operated on top of said SDH/PDH link and said IEEE 802 MAC protocol then is operated end-to-end between said radio network controller and said base station. Said IEEE 802 MAC and IEEE 802 physical layer protocols may for instance be IEEE 802.3 MAC and IEEE 802.3 physical layer protocols, respectively. The IEEE 802.3 physical layer protocol represents an Ethernet network. The use of said Ethernet network may contribute to reduce the cabling costs and the size and costs of the base station.

According to an embodiment of the first aspect of the present invention, said second protocol is an Asynchronous Transfer Mode (ATM) protocol. The ATM protocol relies on cell-switching technology. ATM cells have a fixed length of 53 bytes which allows for very fast switching. ATM creates pathways between end nodes called virtual circuits which are identified by the Virtual Path Identifier (VPI) and Virtual Channel Identifier (VCI) values. The ATM layer is then end-to-end between said radio network controller and said base station, and said base station provides full functionality on the ATM layer and layers above. Said base station may then be configured as in prior art, and only said base station hub may require additional configuration, for instance configuration as it is performed for an ATM cross-connect. In said base station hub, then a mapping table may be used to translate ATM interface parameters, VPIs and VCIs into MAC addresses for the Ethernet.

According to an embodiment of the first aspect of the present invention, said base station hub is an ATM cross-connect. Said base station hub then provides an ATM layer itself, which is understood not to terminate said ATM protocol operated between said base station and said radio network controller. Said ATM layer provided by said base station hub then at least partially performs interworking of said second-type physical layer protocol and said first protocol and optionally modifying of values in the cell header of ATM cells being exchanged between said base station and said radio network controller.

For the transport of ATM cells over an IEEE 802 physical layer protocol, e.g. an Ethernet network, it may also be possible to use one of the methods defined within IETF's PWE3 working group, e.g. the “Encapsulation Methods for Transport of ATM Over MPLS Networks” as described in “draft-ietf-pwe3-atm-encap-07.txt”

According to an embodiment of the first aspect of the present invention, said method further comprises interworking said second-type physical layer protocol and said first-type physical layer protocol in said base station hub while not terminating a protocol that is operated between said at least one base station and said radio network controller for a transmission of said data on top of said first-type physical layer protocol and second-type physical layer protocol. Said first-type and second-type physical layer protocol may then be directly interworked. Said protocol may for instance be an ATM protocol.

According to an embodiment of the first aspect of the present invention, said method further comprises operating an ATM protocol for a transmission of said data between said at least one base station and said radio network controller, wherein said ATM protocol is not terminated by said base station hub. Any interworking then has to take place with protocols operated below said ATM protocol. It may then in particular be possible that said first-type and second-type physical layer protocol are directly interworked.

According to an embodiment of the first aspect of the present invention, parameters required for said interworking in said base station hub are defined by an operator of said radio access network during network configuration. Said parameters may for instance be related to a cell rate for each Virtual Channel Connection (VCC) in the ATM layer that is required to be known to said base station hub for policing.

According to an embodiment of the first aspect of the present invention, parameters required for said interworking in said base station hub are defined by a proprietary protocol that is operated between said at least one base station and said base station hub. Configuration of said base station hub then is performed by said at least one base station, for instance for each of its VCCs.

Second Aspect of the Invention

According to an embodiment of a second aspect of the present invention, said method further comprises operating a first protocol for a transmission of said user data between said at least one base station and said base station hub on top of said first-type physical layer protocol and a second protocol for a transmission of said user data between said at least one base station and said base station hub on top of said first protocol; operating a third protocol for a transmission of said user data between said base station hub and said radio network controller on top of said second-type physical layer protocol, and interworking said second and third protocol in said base station hub while not terminating a fourth protocol that is operated between said at least one base station and said radio network controller for a transmission of said user data on top of said second and third protocol.

According to an embodiment of the second aspect of the present invention, said first protocol is an IEEE 802 MAC protocol, said third protocol is an ATM protocol, and said fourth protocol is an AAL2 CPS protocol. According to this embodiment of the present invention, said ATM protocol is terminated by said base station hub towards said radio network controller. Said AAL2 CPS protocol operated between said radio network controller and said base station then is not terminated by said base station hub.

According to an embodiment of the second aspect of the present invention, said second protocol is a proprietary protocol. This proprietary protocol may for instance be defined by a manufacturer of said base station hub and/or said base station.

According to an embodiment of the second aspect of the present invention, said second protocol represents a combination of a UDP protocol and an underlying IP protocol. Said User Datagram Protocol (UDP), defined by IETF RFC 768, provides a simple, but unreliable message service for transaction-oriented services. Each UDP header carries both a source port identifier and destination port identifier, allowing high-level protocols to target specific applications and services among hosts. The Internet Protocol (IP), defined by IETF RFC 791, is the routing layer datagram service of the TCP/IP suite. The IP frame header contains routing information and control information associated with datagram delivery.

According to an embodiment of the second aspect of the present invention, said method further comprises operating a first protocol for a transmission of said user data between said at least one base station and said base station hub on top of said first-type physical layer protocol; operating a second protocol for a transmission of said user data between said base station hub and said radio network controller on top of said second-type physical layer protocol, and interworking said first and second protocol in said base station hub while not terminating a third protocol that is operated between said at least one base station and said radio network controller for a transmission of said user data on top of said second and third protocol. Said interworking then takes place directly between said first and second protocols that reside on said first-type and second-type physical layer protocols, respectively. Said first protocol may for instance be an IEEE 802.3q protocol representing a MAC protocol for a Virtual Local Area Network (VLAN). A VLAN may be understood as a switched network that is logically segmented on an organizational basis, by functions, project teams, or applications rather than on a physical or geographical basis. Said third protocol may for instance be an AAL2 CPS protocol.

According to an embodiment of the second aspect of the present invention, said method further comprises operating an AAL2 protocol for a transmission of said user data between said at least one base station and said radio network controller, wherein said AAL2 protocol is not terminated by said base station hub. Any interworking then has to take place with protocols operated below said AAL2 protocol.

According to an embodiment of the second aspect of the present invention, said data that is transmitted between said at least one base station and said radio network controller via said base station hub further comprises transport network control data related to a control signalling in a transport network layer of said radio access network, said control signalling is performed by a first-type control protocol that is operated between said at least one base station and said base station hub, and a second-type control protocol that is operated between said base station hub and said radio network controller, and in said base station hub, an interworking of said first-type and second-type control protocol is performed.

According to an embodiment of the second aspect of the present invention, said second-type control protocol is an ALCAP protocol. Said ALCAP protocol may for instance be the Q.2630.2 protocol used in the transport network control plane of a UTRAN. Said first-type control protocol may for instance be a proprietary protocol, and may be IP-based.

According to an embodiment of the second aspect of the present invention, said data that is transmitted between said at least one base station and said radio network controller via said base station hub further comprises radio network control data related to a control signalling in a radio network layer of said radio access network, said method further comprising operating a fifth protocol for a transmission of said radio network control data between said at least one base station and said base station hub on top of said first-type physical layer protocol and a sixth protocol for a transmission of said radio network control data between said at least one base station and said base station hub on top of said fifth protocol; operating a seventh protocol for a transmission of said radio network control data between said base station hub and said radio network controller on top of said second-type physical layer protocol and an eighth protocol for a transmission of said radio network control data between said base station hub and said radio network controller on top of said seventh protocol; interworking said sixth protocol and said eighth protocol in said base station hub while not terminating a ninth protocol that is operated between said at least one base station and said radio network controller for a transmission of said radio network control data on top of said sixth protocol) and said eighth protocol.

Said radio access network may for instance be a UTRAN, and then said radio network control data may represent the messages of an application protocol.

According to an embodiment of the second aspect of the present invention, said fifth protocol is an IEEE 802 MAC protocol, said sixth protocol is a multiplexing protocol, said seventh protocol is an ATM protocol, said eighth protocol is an AAL5 protocol, and said ninth protocol is an SSCF-UNI protocol on top of an SSCOP protocol. Said multiplexing protocol may for instance represent functionality to identify said radio network control data by EtherType or VLAN IDs (VIDs). For instance, radio bearers could be identified by using either different (proprietary) EtherType values or different VIDs. SSCF denotes the Service Specific Coordination Function protocol, UNI denotes the User to Network Interface protocol, and SSCOP denotes the Service Specific Connection Oriented Protocol.

According to an embodiment of the second aspect of the present invention, said data that is transmitted between said at least one base station and said radio network controller via said base station hub further comprises radio network control data related to a control signalling in a radio network layer of said radio access network, said method further comprising operating an SSCF-UNI protocol on top of an SSCOP protocol for a transmission of said user data between said at least one base station and said radio network controller, wherein said SSCF-UNI and SSCOP protocols are not terminated by said base station hub. Any interworking then has to take place with protocols below said SSCF-UNI and SSCOP protocols.

According to an embodiment of the second aspect of the present invention, at least one protocol related to a control signalling between said at least one base station and said radio network controller in a radio network layer of said radio access network is terminated in said base station hub, and said base station hub performs said control signalling for said at least one base station. This may for instance accomplished by a proprietary protocol that is operated between said base station hub and said at least one base station. This proprietary protocol may for instance be IP-based.

According to an embodiment of the second aspect of the present invention, said at least one protocol is an NBAP protocol.

According to an embodiment of the second aspect of the present invention, said data that is transmitted between said at least one base station and said radio network controller via said base station hub further comprises management data related to a management of said at least one base station, and said method further comprises operating a fifth protocol for a transmission of said management data between said at least one base station and said base station hub on top of said first-type physical layer protocol; operating a sixth protocol for a transmission of said management data between said base station hub and said radio network controller on top of said second-type physical layer protocol and a seventh protocol for a transmission of said management data between said base station hub and said radio network controller on top of said sixth protocol; interworking said fifth protocol and said seventh protocol in said base station hub by an eighth protocol operated on top of said fifth protocol and said seventh protocol while not terminating a ninth protocol that is operated between said at least one base station and said radio network controller for a transmission of said management data on top of said eighth protocol.

According to an embodiment of the second aspect of the present invention, said fifth protocol is an IEEE 802 MAC protocol, said sixth protocol is an ATM protocol, said seventh protocol is an AAL5 protocol, said eighth protocol is an IP protocol, and said ninth protocol is a TCP protocol. Said Transport Control Protocol (TCP) is defined by IETF RFC793 and provides a reliable stream delivery and virtual connection service to applications through the use of sequenced acknowledgment with retransmission of packets when necessary.

Third Aspect of the Invention

According to an embodiment of a third aspect of the present invention, said method further comprises operating a first protocol for a transmission of said user data between said at least one base station and said base station hub on top of said first-type physical layer protocol; a second protocol for a transmission of said user data between said at least one base station and said base station hub on top of said first protocol; and a third protocol for a transmission of said user data between said at least one base station and said base station hub on top of said second protocol; operating a fourth protocol for a transmission of said user data between said base station hub and said radio network controller on top of said second-type physical layer protocol; a fifth protocol for a transmission of said user data between said base station hub and said radio network controller on top of said fourth protocol; and a sixth protocol for a transmission of said user data between said base station hub and said radio network controller on top of said fifth protocol; and interworking said third and sixth protocol in said base station hub while not terminating a seventh protocol that is operated between said at least one base station and said radio network controller for a transmission of said user data on top of said third and sixth protocol.

According to an embodiment of the third aspect of the present invention, said first protocol is an IEEE 802 MAC protocol, said second protocol is an IP protocol, said third protocol is a UDP protocol, said fourth protocol is an ATM protocol, said fifth protocol is an AAL2 CPS protocol, said sixth protocol is an AAL2 SSSAR protocol, and said seventh protocol is an FP protocol. Therein, SSSAR denotes the Service Specific Convergence Sublayer. The protocol data units, or frames, of said Frame Protocol (FP) may for instance represent the data streams in the user plane of a UTRAN.

According to an embodiment of the third aspect of the present invention, instead of said second and third protocol, an eighth protocol for a transmission of said user data is operated between said at least one base station and said base station hub on top of said first protocol; said seventh protocol is operated between said at least one base station and said radio network controller for a transmission of said user data on top of said eighth and sixth protocol; and said eighth and sixth protocol are interworked in said base station hub while not terminating said seventh protocol.

According to an embodiment of the third aspect of the present invention, said eighth protocol is a multiplexing protocol.

According to an embodiment of the third aspect of the present invention, said method further comprises operating an FP protocol for a transmission of said user data between said at least one base station and said radio network controller, wherein said FP protocol is not terminated by said base station hub. Said Frame Protocol (FP) may for instance be the FP protocol used in the user plane of a UTRAN. Any interworking then has to take place with protocols operated below said FP protocol.

According to an embodiment of the third aspect of the present invention, said data that is transmitted between said at least one base station and said radio network controller via said base station hub further comprises transport network control data related to a control signalling in a transport network layer of said radio access network, said control signalling is performed by a first-type control protocol that is operated between said at least one base station and said base station hub, and a second-type control protocol that is operated between said base station hub and said radio network controller, and in said base station hub, an interworking of said first-type and second-type control protocol is performed.

According to an embodiment of the third aspect of the present invention, said first-type control protocol is an IP-based ALCAP protocol, and said second-type control protocol is an ATM-based ALCAP protocol. Said IP-based ALCAP may for instance be the Q.2631.1 protocol, and the ATM-based ALCAP may for instance be the Q.2630.2 protocol.

According to an embodiment of the third aspect of the present invention, said data that is transmitted between said at least one base station and said radio network controller via said base station hub further comprises radio network control data related to a control signalling in a radio network layer of said radio access network, and said method further comprises operating an eighth protocol for a transmission of said radio network control data between said at least one base station and said base station hub on top of said first-type physical layer protocol; a ninth protocol for a transmission of said radio network control data between said at least one base station and said base station hub on top of said eighth protocol; and a tenth protocol for a transmission of said radio network control data between said at least one base station and said base station hub on top of said ninth protocol; operating an eleventh protocol for a transmission of said radio network control data between said base station hub and said radio network controller on top of said second-type physical layer protocol, a twelfth protocol for a transmission of said radio network control data between said base station hub and said radio network controller on top of said eleventh protocol, and a thirteenth protocol for a transmission of said radio network control data between said base station hub and said radio network controller on top of said twelfth protocol; and interworking said tenth protocol and said thirteenth protocol in said base station hub while not terminating a fourteenth protocol that is operated between said at least one base station and said radio network controller for a transmission of said radio network control data on top of said tenth protocol and said thirteenth protocol.

According to an embodiment of the third aspect of the present invention, said eighth protocol is an IEEE 802 MAC protocol, said ninth protocol is an IP protocol, said tenth protocol is an SCTP protocol, said eleventh protocol is an ATM protocol, said twelfth protocol is an AAL5 protocol, said thirteenth protocol is an SSCF-UNI protocol on top of an SSCOP protocol, and said fourteenth protocol is an NBAP protocol.

According to an embodiment of the third aspect of the present invention, said data that is transmitted between said at least one base station and said radio network controller via said base station hub further comprises radio network control data related to a control signalling in a radio network layer of said radio access network, said method further comprising operating a protocol for a transmission of said radio network control data between said at least one base station and said radio network controller, wherein said protocol is not terminated by said base station hub.

According to an embodiment of the third aspect of the present invention, said protocol is an NBAP protocol.

According to an embodiment of the third aspect of the present invention, said data that is transmitted between said at least one base station and said radio network controller via said base station hub further comprises management data related to a management of said at least one base station, said method further comprising operating an eighth protocol for a transmission of said management data between said at least one base station and said base station hub on top of said first-type physical layer protocol and a ninth protocol for a transmission of said management data between said at least one base station and said base station hub on top of said eighth protocol; operating a tenth protocol for a transmission of said management data between said base station hub and said radio network controller on top of said second-type physical layer protocol and an eleventh protocol for a transmission of said management data between said base station hub and said radio network controller on top of said tenth protocol; interworking said ninth protocol and said eleventh protocol in said base station hub by a twelfth protocol operated on top of said ninth protocol and said eleventh protocol while not terminating a thirteenth protocol that is operated between said at least one base station and said radio network controller for a transmission of said management data on top of said twelfth protocol.

According to an embodiment of the third aspect of the present invention, said eighth protocol is an IEEE 802 MAC protocol, said ninth protocol is an IP protocol, said tenth protocol is an ATM protocol, said eleventh protocol is an AAL5 protocol, said twelfth protocol is an end-to-end IP protocol and said thirteenth protocol is a TCP protocol. Then IP tunnelling is done via said IP transport layer.

Fourth Aspect of the Invention

According to an embodiment of a fourth aspect of the present invention, a management unit uses a first-type management protocol to cause said at least one base station to perform management-related operations, and wherein at least one of said management-related operations is performed by said base station hub instead of said at least one base station.

According to an embodiment of the fourth aspect of the present invention, said management-related operations comprise at least one of fault handling operations, configuration operations, accounting operations, performance measurement operations, security operations, software management operations, hardware management operations, operations related to an aggregation of alarms and operations related to a filtering of alarms. These operations may typically be triggered by a management unit of a management system, for instance an O&M server in a UTRAN.

According to an embodiment of the fourth aspect of the present invention, said base station hub terminates said first-type management protocol towards said management unit and operates a second-type management protocol with said at least one base station. Said second-type management protocol may for instance be a proprietary protocol that allows said base station hub to manage said at least one base station.

According to an embodiment of the fourth aspect of the present invention, said second-type management protocol is an IP-based protocol.

According to an embodiment of the fourth aspect of the present invention, said data is transmitted between a plurality of base stations and said radio network controller, and said base station hub operates said first-type physical layer protocol for a transmission of said data between said base station hub and said plurality of base stations.

According to an embodiment of the fourth aspect of the present invention, said radio network controller considers said base station hub and said plurality of base stations as a single base station.

According to an embodiment of the fourth aspect of the present invention, said base station hub supports a softer handover. Said softer handover denotes the situation where a mobile station that is served by a first base station of said plurality of base stations changes to a second base station of said plurality of base stations, and wherein during said change, said mobile station is served by both base stations.

It is further proposed a system for data transmission in a radio access network, said system comprising a radio network controller; a base station hub; and at least one base station; wherein said base station hub and said at least one base station comprise means arranged for operating a first-type physical layer protocol for a transmission of said data between said at least one base station and a base station hub; wherein said base station hub and said radio network controller comprise means arranged for operating a second-type physical layer protocol for a transmission of said data between said base station hub and said radio network controller; wherein said data comprises user data that is transmitted between said radio network controller and said at least one base station via said base station hub; and wherein said at least one base station comprises means arranged for performing at least base band processing for signals that are transmitted via a radio interface and represent said user data. Said system may for instance be a radio network sub-system in a UTRAN.

It is further proposed a base station for data transmission in a radio access network, said base station comprising means arranged for operating a first-type physical layer protocol for a transmission of said data between said base station and a base station hub; wherein said data is transmitted between said base station hub and said radio network controller according to a second-physical layer protocol; and wherein said data comprises user data that is transmitted between said radio network controller and said at least one base station via said base station hub; and means arranged for performing at least base band processing for signals that are transmitted via a radio interface and represent said user data.

It is further proposed a software application executable in a base station in a radio access network, said software application comprising program code for causing said base station to operate a first-type physical layer protocol for a transmission of said data between said base station and a base station hub; wherein said data is transmitted between said base station hub and said radio network controller according to a second-physical layer protocol; and wherein said data comprises user data that is transmitted between said radio network controller and said at least one base station via said base station hub; and program code for causing said base station to perform at least base band processing for signals that are transmitted via a radio interface and represent said user data.

It is further proposed a base station hub for data transmission in a radio access network, said base station hub comprising means arranged for operating a first-type physical layer protocol for a transmission of said data between at least one base station and said base station hub; means arranged for operating a second-type physical layer protocol for a transmission of said data between said base station hub and a radio network controller; wherein said data comprises user data that is transmitted between said radio network controller and said at least one base station via said base station hub; and wherein said at least one base station performs at least base band processing for signals that are transmitted via a radio interface and represent said user data.

It is further proposed a software application executable in a base station hub in a radio access network, said software application comprising program code for causing said base station hub to operate a first-type physical layer protocol for a transmission of said data between at least one base station and said base station hub; and program code for causing said base station hub to operate a second-type physical layer protocol for a transmission of said data between said base station hub and a radio network controller; wherein said data comprises user data that is transmitted between said radio network controller and said at least one base station via said base station hub; and wherein said at least one base station performs at least base band processing for signals that are transmitted via a radio interface and represent said user data.

These and other aspects of the invention will be apparent from and elucidated with reference to the embodiments described hereinafter.

### BRIEF DESCRIPTION OF THE FIGURES

In the figures show:

FIG. 1: A schematic presentation of the network elements of a Universal Mobile Telecommunications System (UMTS) according to the prior art;

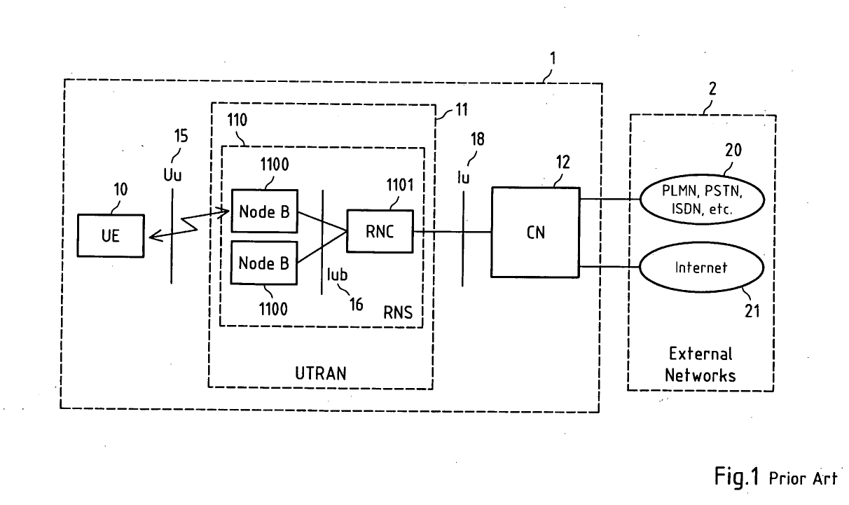

FIG. 2: a schematic presentation of the protocol structure for the UMTS Terrestrial Radio Access Network (UTRAN) interfaces according to the prior art;

FIG. 3: a schematic presentation of the protocol structure for the UTRAN Iub interface according to the prior art;

FIG. 4: a schematic presentation of an exemplary system according to the present invention;

FIG. 5a: a first exemplary protocol architecture for the user plane of a first embodiment of the present invention;

FIG. 5b: a first exemplary protocol architecture for the radio network control plane of a first embodiment of the present invention;

FIG. 5c: a second exemplary protocol architecture for the user plane of a first embodiment of the present invention;

FIG. 5d: a second exemplary protocol architecture for the radio network control plane of a first embodiment of the present invention;

FIG. 6a: an exemplary protocol architecture for the user plane of a second embodiment of the present invention;

FIG. 6b: an exemplary protocol architecture for the transport network control plane of a second embodiment of the present invention;

FIG. 6c: an exemplary protocol architecture for the radio network control plane of a second embodiment of the present invention;

FIG. 6d: an exemplary protocol architecture for a management plane of a second embodiment of the present invention;

FIG. 6e: an exemplary protocol architecture for the radio network control plane of a second embodiment of the present invention with the base station hub terminating the NBAP protocol (allows for centralized control of the base stations connected to a base station hub);

FIG. 6f: an exemplary protocol architecture for a management plane of a second embodiment of the present invention with the base station hub terminating the operation and maintenance protocol (allows for centralized management of the base stations connected to a base station hub);

FIG. 7a: an exemplary protocol architecture for the user plane of a third embodiment of the present invention;

FIG. 7b: an exemplary protocol architecture for the transport network control plane of a third embodiment of the present invention;

FIG. 7c: an exemplary protocol architecture for the radio network control plane of a third embodiment of the present invention; and

FIG. 7d: an exemplary protocol architecture for a management plane of a third embodiment of the present invention.

### DETAILED DESCRIPTION OF THE INVENTION

The present invention proposes the introduction of a new network element, which is denoted as “base station hub”, into a radio access network. One or more base stations can be connected to said base station hub, wherein said base stations perform at least base band processing for signals that are transmitted via their radio interfaces. Said base station hub allows for the deployment of different physical layer protocols on the link between the base station hub and the one or more base stations on the one hand, and the link between the base station hub and a radio network controller of said radio access network on the other hand.

In the sequel of this detailed description of the invention, embodiments of the present invention will be described in the context of the UMTS Terrestrial Radio Access Network (UTRAN). It has to be understood that the choice of this radio access network is only of exemplary nature and is by no means intended to limit the applicability of the present invention to radio access networks of other radio systems, as for instance mobile radio communications systems or wireless Local Area Networks (WLANs).

It should furthermore be noted that the description in the opening part of this patent specification is suited to support this detailed description and is therefore understood to be incorporated into this detailed description of the invention by reference.

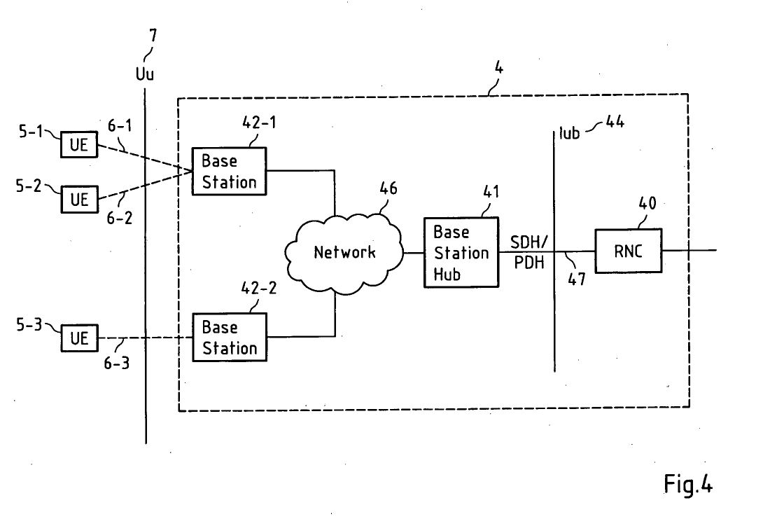

FIG. 4 depicts a basic set-up of a system 4 according to the present invention. The system 4 is a Radio Network Sub-system (RNS) of a UTRAN and comprises a Radio Network Controller (RNC) 40, a base station hub 41 and two base stations 42-1 and 42-2. Said base station hub 41 is connected to its associated RNC 40 via an SDH/PDH link 47 on the Iub interface 44. In contrast, said base stations 42-1 and 42-2 are connected to said base station hub 41 via a network 46. Throughout the embodiments presented in this detailed description of the present invention, this network 46 is assumed to be an Ethernet (IEEE 802.3) network. It is readily understood that this choice is of exemplary nature and not intended to limit the scope of the present invention. In particular, any other wire-bound or wireless network technology may be deployed, as for instance other IEEE 802 networks such as a Wireless Local Area Network (WLAN, IEEE 802.11) or a WiMAX network (IEEE 802.16), to name but a few.

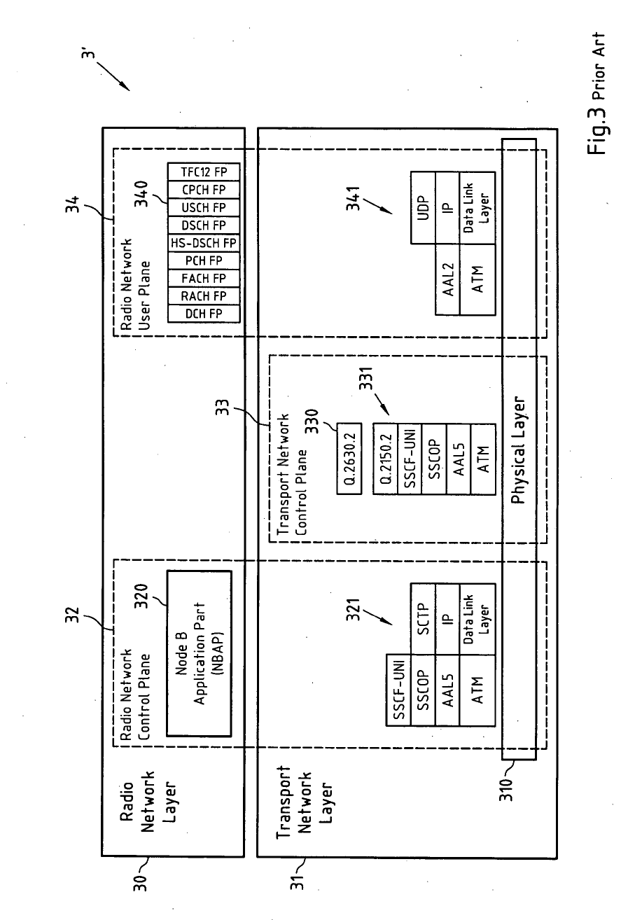

Furthermore, it is to be understood that, instead of two base stations 42-1 and 42-1, every other number of base stations can be connected to said RNC 40, for instance only one base station may be connected to said RNC 40. In FIG. 4, also mobile stations 5-1 . . . 5-3 are depicted, which are connected to their associated base stations 42-1 and 42-2 via wireless links 6-1 . . . 6-3 across the Uu interface 7. To this end, each of said base stations 42-1 and 42-2 comprises Radio Frequency (RF) transceivers and amplifiers, mixers for a conversion of signals between RF and digital base band, channel modems and means for base band processing, such as for instance equalization, spreading/de-spreading, scrambling/de-scrambling, channel estimation and further base band processing. Said base stations 42-1 and 42-2 are thus capable of transforming data streams 340 of a user plane 34 (see FIG. 3) of a UTRAN into RF signals that then can be transmitted between said base stations 42-1 and 42-2 and their associated mobile stations 5-1 . . . 5-3, respectively.

The connection of the base stations 42-1 and 42-2 to the base station hub 41 via the Ethernet network 46 is a comparably cheap (both from an equipment and a maintenance point of view) and mature technology. In particular, existing Ethernet 46 cabling may be re-used, for instance by re-using LAN infrastructure in buildings. A distance from an RNC to a building with an installed Ethernet then may for instance be covered by an SDH/PDH link 47 that connects to a base station hub 41 in or close to said building, and the connection of one or more base stations 42-1 and 42-2 within the building is then accomplished via the Ethernet 46.

Comparing the base stations 42-1 and 42-2 of the system 4 according to the present invention to legacy UMTS Node Bs, these base stations 42-1 and 42-2 can be considered as legacy UMTS Node Bs with partially outsourced functionalities. These outsourced functionalities, as for instance transmission functionality (e.g. SDH/PDH interfaces) and transport functionalities (e.g. AAL2/5 and ATM protocol instances), have been concentrated in said base station hub 41. As will be discussed below, outsourced functionalities can equally well relate to control and management. The outsourcing of functionalities renders the base stations 42-1 and 42-2 according to the present invention small and cheap. Outsourced functionalities can be concentrated in the base station hub 41 and may thus be more efficiently used.

Comparing the base stations 42-1 and 42-2 of the system 4 according to the present invention to prior art distributed base stations (for instance distributed base stations according to OBSAI or CPRI, i.e. consisting of a base station head with RF processing and a base station body with a processing module for base band processing and a transport for interfacing, for instance with an Iub interface), said base stations 42-1 and 42-2 can be considered as modified base station heads into which base band processing functionality has been integrated. Correspondingly, said base station hub 41 then can be considered as a modified base station body that has been deprived of the base band processing functionality. In the context of distributed base stations, the integration of the base band processing into the modified base station heads (base stations 42-1 and 42-2) allows to reduce the data rate on the link between the modified base station head and the modified base station body (which in prior art requires a fibre connection), so that an Ethernet network can be used as physical layer protocol for this link.

In the base stations 42-1 and 42-2 according to the present invention, which perform at least base band processing, a base band Application Specific Integrated Circuit (ASIC) may for instance directly interface with the RF components, the A/D converters and the D/A converters, thus dismissing multiple bus structures and software components in the chain from the A/D and D/A converters to the base station hub 41. The architecture and potentially small size of the base stations 42-1 and 42-2 (due to the use of Ethernet as transmission technique instead of SDH/PDH or fibre) may allow for a direct access of the base station to its respective antenna (due to the freedom in placing the reduced-size base station) without requiring RF cabling. The reduced or even non-existing cabling loss may allow the use of a cheaper power amplifier.

To keep the system 4 according to the present invention conform to the UMTS standard, it may be advantageous that the Iub interface 44 as such is not modified. Then, as seen from the RNC 40, said base station hub 41 with its associated base stations 42-1 and 42-2 may either appear as a single legacy UMTS Node B, or as two legacy UMTS Node Bs, depending on the way the protocol architecture in the base station hub 41 and in the base stations 42-1 and 42-2 is designed.

In a network layer of the Ethernet link 46, IP could be used, but this is not a necessity of the present invention. However, in this case, an IP-routed network can be used between the base station hub 41 and its associated base stations 42-1 and 42-2.

The base station hub 41 may provide functionality to map data and signalling bearers between ATM-based and Ethernet-based traffic. Especially for the data bearers, it may have to take the properties of the used Ethernet network (including also low capacity links) into account (like delay depending on packet sizes, head of line blocking, etc.) in order to fulfil the Iub interface delay and delay variation targets.

Said base station hub 41 may further modify the management and radio network control plane information, so that, for the RNC 40, it may not be noticeable that the base stations 42-1 and 42-2 are connected via the base station hub 41 and not directly with the RNC 40. This may particularly affect the NBAP and Operation and Maintenance (O&M) protocols.

The base station hub 41 may also provide synchronization information over the Ethernet 46, which synchronization information may be required by the base stations 42-1 and 42-2 to run their radio interfaces properly. The base station hub 41 itself may either be synchronized to the transmission network (SDH/PDH), or may derive the synchronization from an external source, such as for instance via GPS.

There exist several possibilities regarding the interface between the base station hub 41 and the base stations 42-1 and 42-2, which also determine the required processing functionality in said node. In this detailed description, three different embodiments of the present invention that propose how the user plane data can be transported over Ethernet will be exemplarily presented. The radio network control plane, transport network control plane and management plane are then adopted accordingly.
First embodiment: One or multiple ATM cells are transported in an Ethernet frame (optionally there could be an additional transport layer). The ATM protocol between the RNC 40 and the base stations 42-1 and 42-2 is not terminated.
Second embodiment: One or multiple AAL2 CPS packets are transported in an Ethernet frame (optionally there could be an additional transport layer). The AAL2 CPS protocol between the RNC 40 and the base stations 42-1 and 42-2 is not terminated. The ATM protocol is terminated in the base station hub.
Third embodiment: One or multiple FP frames are transported in an Ethernet frame (optionally there could be a transport layer, e.g. UDP/IP as specified by 3GPP for Iub/IP or a proprietary protocol). The FP protocol between the RNC 40 and the base stations 42-1 and 42-2 is not terminated. ATM and AAL2 protocols are terminated in the base station hub.

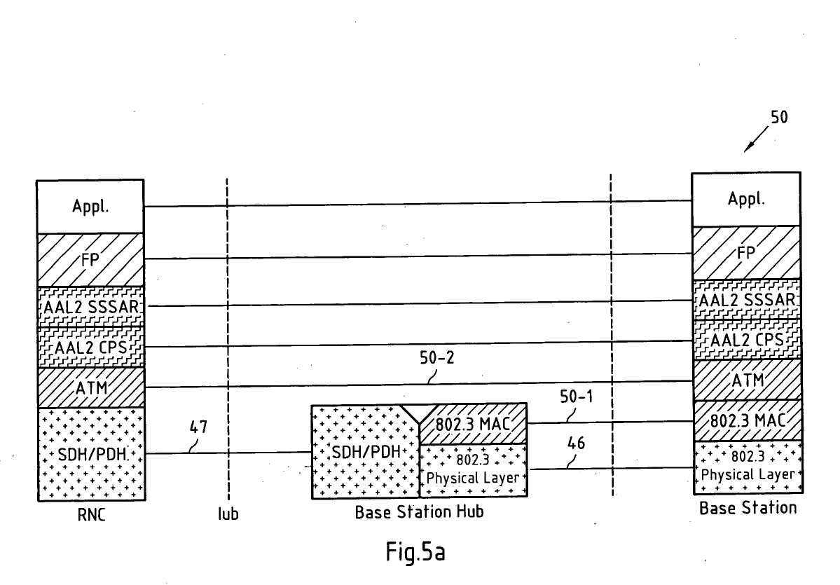

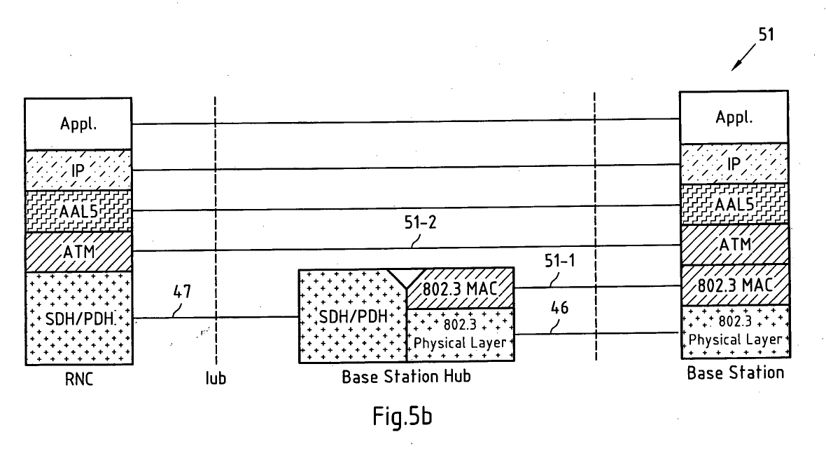

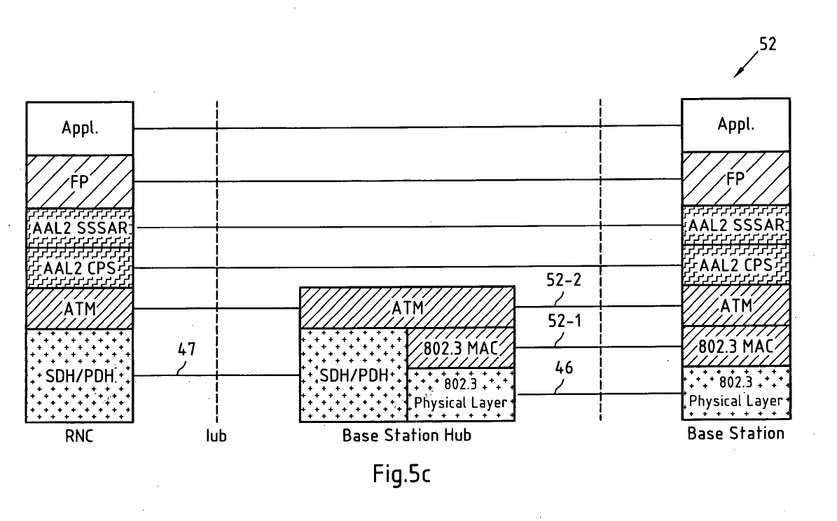

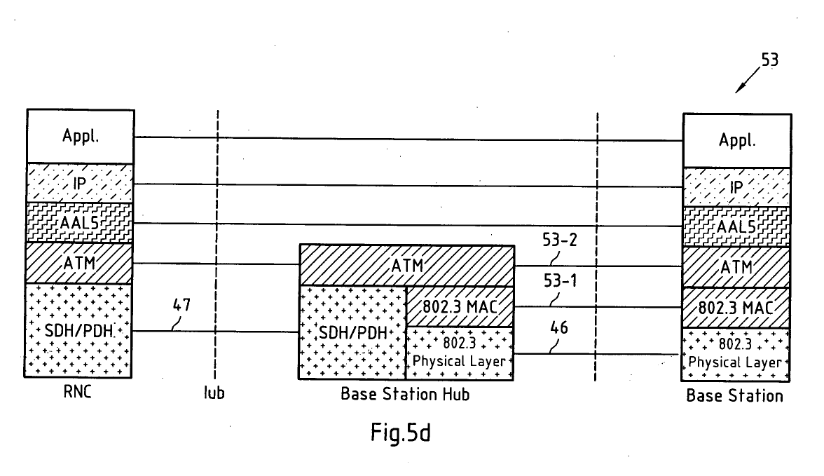

Exemplary protocol architectures for the user plane, transport network control plane, radio network control plane and management plane with respect to the above-listed three embodiments of the present invention will be presented now with reference to FIGS. 5a-7d.

### First Embodiment

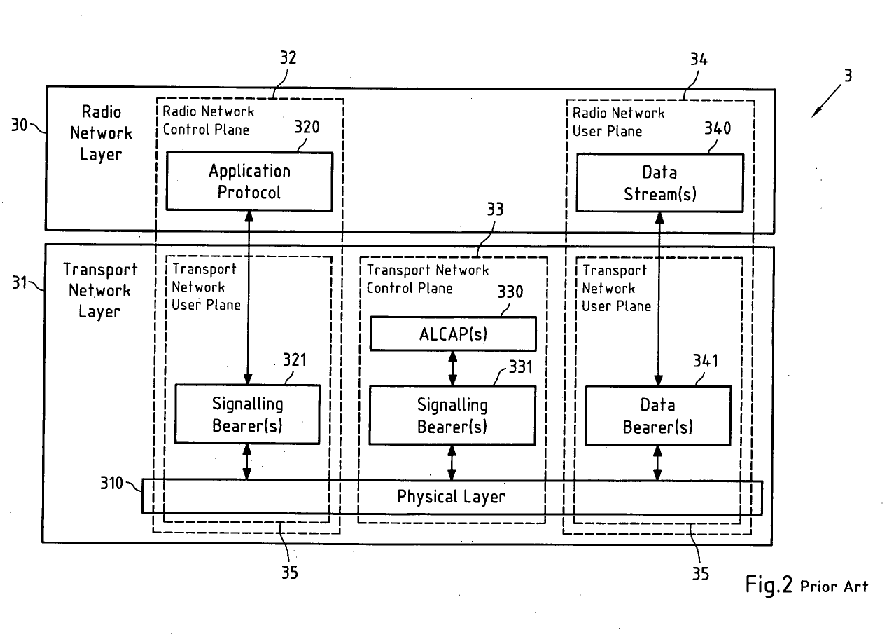

FIG. 5a depicts a first exemplary user plane protocol architecture 50 for the transmission of data streams 340 (see FIG. 2) over data (or transport) bearers 341 in the user plane 34 of a UTRAN according to the first embodiment of the present invention. Therein, said data streams 340 contain data from applications running on the top-most layer of the protocol architecture, for instance speech, and consist of a plurality of Frame Protocol (FP) frames. The data streams are transmitted between a base station (for instance the base station 42-1 of FIG. 4) and an RNC (for instance the RNC 40 of FIG. 4) via a base station hub (for instance the base station hub 41 of FIG. 4).

According to the first embodiment of the present invention, the ATM protocol 50-2 operated between the RNC and the base station for the transmission of user plane data streams 340 is not terminated in the base station hub. The FP frames are converted into ATM cells by the AAL2 protocol layers, i.e. AAL2 SSSAR and AAL2 CPS, and these ATM cells are then transported over the Ethernet (represented by an IEEE 802.3 physical layer protocol 46) to the base station hub (see right side of the protocol architecture 50). Therein, the IEEE 802.3 MAC protocol 46 serves as medium access control protocol for the Ethernet. In the base station hub, a conversion between the IEEE 802.3 MAC protocol 46 and the PDH/SDH protocol 47 operated between the RNC and the base station hub (see left side of the protocol architecture 50) is performed. The base station hub thus acts as a media converter between the Ethernet network and the PDH/SDH links. To this end, a mapping table may be implemented in the base station hub, which maps ATM interface parameters, Virtual Path Identifiers (VPI) and Virtual Channel Identifiers (VCI) of ATM connections to MAC addresses to be used in the Ethernet network.

The transport of the ATM cells over the Ethernet network may for instance be accomplished in native fashion, or with a Virtual LAN (VLAN) and/or priorities according to the IEEE 802.3q standard, or e.g. by ATM over packet network encapsulation as defined by IETF.

According to this first embodiment of the present invention, the base station has to provide full functionality on the ATM layer 50-2 and the layers above. However, the use of PDH/SDH interfaces in the base station will no longer be required due to the use of an Ethernet network on the link between base station hub and base station, which will reduce the complexity and size of the base station.

FIG. 5b depicts a first exemplary protocol architecture 51 according to the first embodiment of the present invention, wherein said protocol architecture is suited to represent a radio network control plane protocol architecture for the transmission of NBAP 320 messages (see FIGS. 2 and 3) over signalling bearers 321 in the radio network control plane 32 of a UTRAN.

As can be readily seen, the ATM protocol 51-2 between the RNC and the base station is not terminated by the base station hub in the protocol architecture 51. The conversion of the IEEE 802.3 MAC protocol 51-1 into the PDH/SDH protocol 47 can be accomplished similarly as described for FIG. 5a.

FIG. 5c depicts a second exemplary user plane protocol architecture 52 for the transmission of data streams 340 (see FIG. 2) over data (or transport) bearers 341 in the user plane 34 of a UTRAN according to the first embodiment of the present invention. FIG. 5d depicts the corresponding radio network control plane protocol architecture 53.

In contrast to the first exemplary user plane protocol architecture 50 of FIG. 5a, the base station hub in the protocol architecture 52 of FIG. 5c provides an own ATM layer on top of the 802.3 MAC layer 52-1 and the SDH/PDH protocol 47, for interworking these two protocols. This allows ATM cells to be end-to-end transferred between the base station and the radio network controller, i.e. the ATM protocol 52-2 is not terminated by the base station hub. The functionality provided by the base station hub in this second exemplary user plane protocol architecture 52 then represents the functionality of an ATM cross-connect, so that the base station hub may thus be embodied by an ATM cross-connect. This also holds for the corresponding radio network control plane protocol architecture 53 of FIG. 5d, where the 802.3 MAC protocol is denoted as 53-1, and the end-to-end ATM protocol between base station and radio network controller is denoted as 53-2.

According to both presented examples of the first embodiment of the present invention, the base station hub is acting as a media converter, but still may have to know for policing on the ATM interface the cell rate of each Virtual Channel Connection (VCC). These parameters may be set explicitly during network configuration by an operator. Alternatively, each base station may configure its associated base station hub by itself for each of its VCCs, for instance be using a proprietary protocol.

The first embodiment of the present invention allows for a simple implementation of the base station hub. For instance, a modified (and complexity reduced) base station body from a distributed base station architecture could be used.

### Second Embodiment

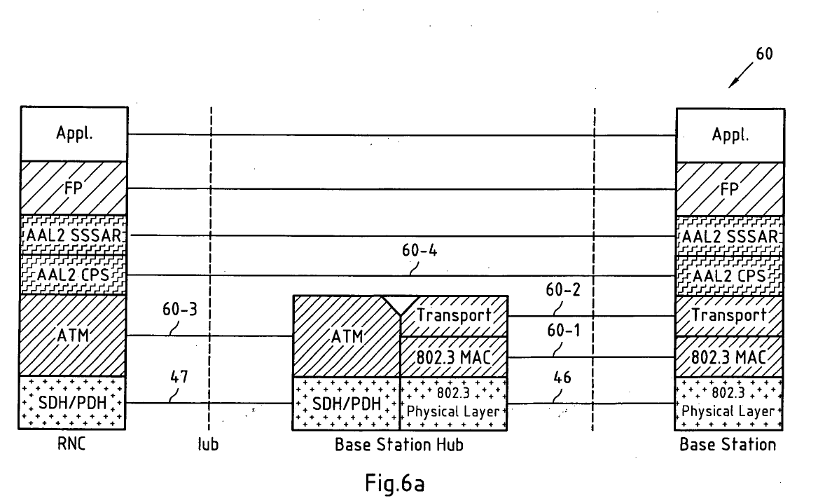

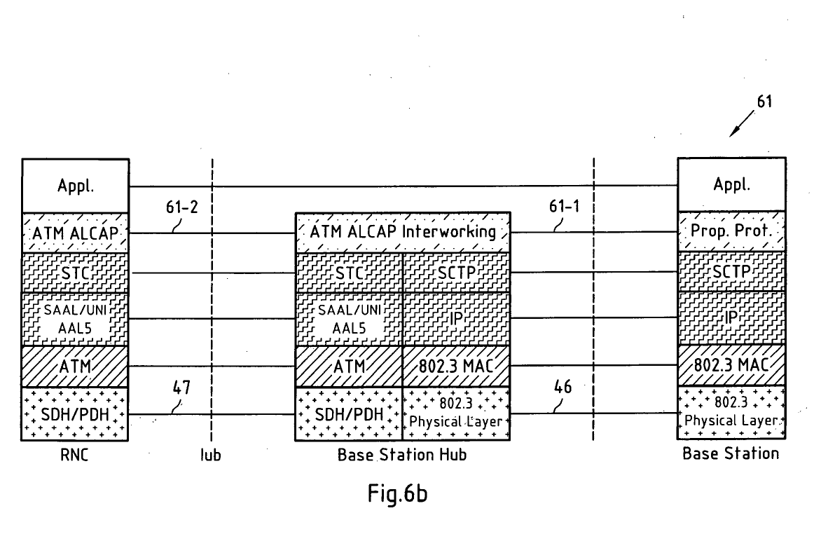

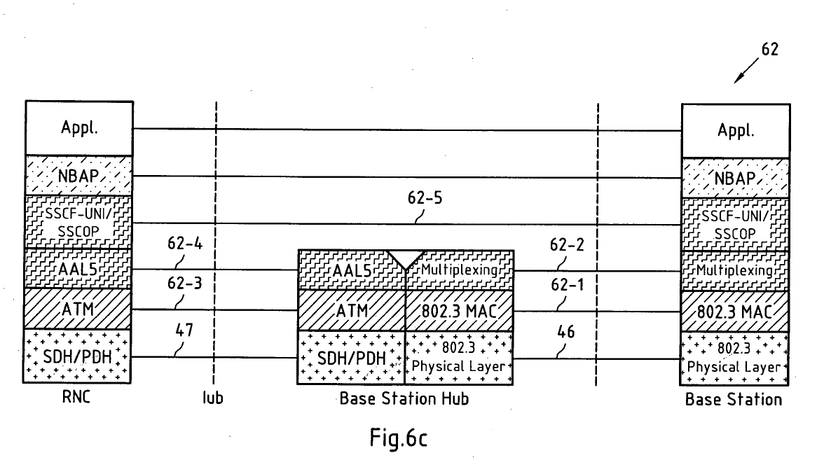

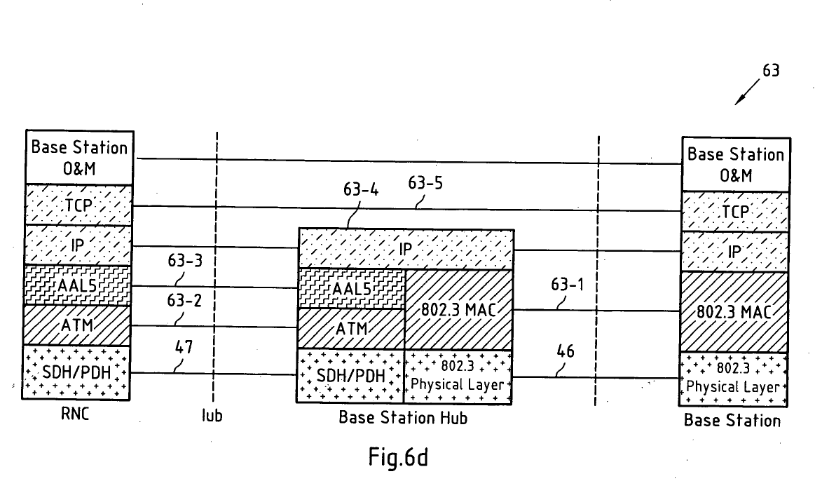

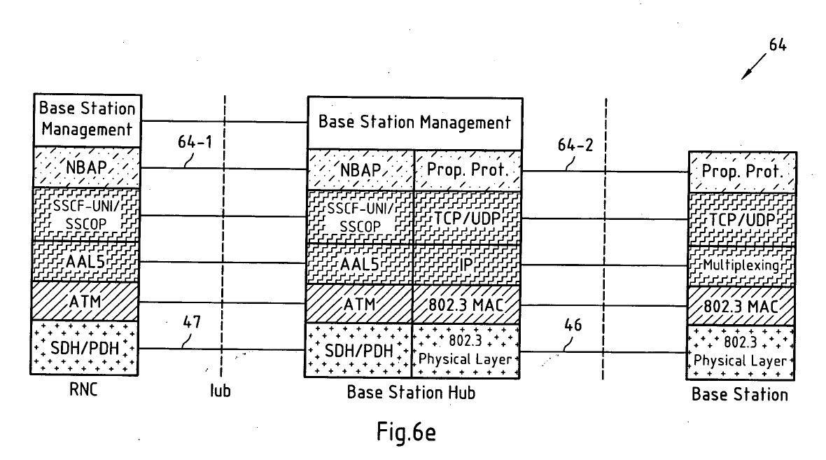

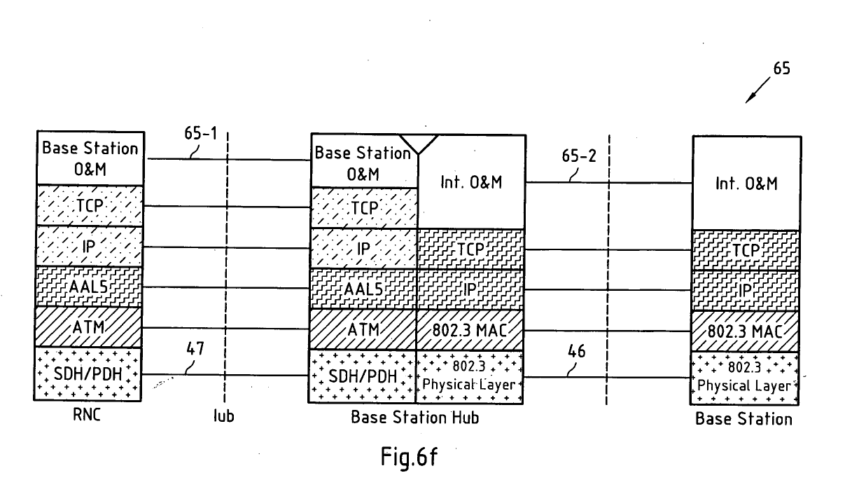

FIG. 6a depicts a user plane protocol architecture 60 for the transmission of data streams 340 (see FIG. 2) over data (or transport) bearers 341 in the user plane 34 of a UTRAN according to the second embodiment of the present invention. Therein, it is readily seen that the AAL2 CPS protocol 60-4 operated between the RNC and the base station is not terminated by the base station hub, so that AAL2 CPS packets are transmitted over the Ethernet network. This can be achieved with a transport layer 60-2 above the IEEE 802.3 MAC layer 60-1, which may for instance be implemented by using a proprietary header or even IP/UDP.

In the base station hub, this transport layer is then interworked with the ATM layer 60-3 used on top of the PDH/SDH physical layer protocol 47 operated between the RNC and the base station hub (see the left side of the protocol architecture 60). This may be achieved by a mapping table, which maps ATM interface parameters, VPIs, VCIs and CIDs into MAC addresses and VIDs.

As an alternative to the protocol architecture 60 of FIG. 6a, it is also possible to use an IEEE 802.3q (VLAN MAC) protocol instead of the IEEE 802.3 MAC protocol 60-1 and the transport layer 60-2. Then, interworking takes places between the IEEE 802.3q layer and the ATM layer 60-3.

FIG. 6b depicts a transport network control plane protocol architecture 61 for the transmission of ALCAP 330 messages (see FIG. 2 and FIG. 3) over signalling bearers 331 in the transport network control plane 33 of a UTRAN according to the second embodiment of the present invention. In the second embodiment of the present invention, the ALCAP 61-2 is terminated by the base station hub towards the RNC, and a proprietary protocol 61-1 is used for the transport network control plane signalling instead (see right side of the protocol architecture 61). This proprietary protocol 61-1 may for instance be IP-based.

FIG. 6c depicts a radio network control plane protocol architecture 62 for the transmission of NBAP 320 messages (see FIG. 2) over signalling bearers 321 in the radio network control plane 32 of a UTRAN according to the second embodiment of the present invention.

Apparently, the SSCF-UNI/SSCOP protocol 62-5 operated between the RNC and the base station is not terminated by the base station hub in the radio network control plane protocol architecture 62. Thus AAL5 service data units are end-to-end transported between RNC and base station.

According to the second embodiment of the present invention, radio network control plane data, i.e. NBAP messages, may for instance be identified by EtherType or VLAN IDs (for instance different radio bearers could be identified by using different (proprietary) EtherType values or VLAN IDs), or an explicit multiplexing layer 62-2. The latter alternative is depicted in FIG. 6c, where said multiplexing layer 62-2 resides on top of the IEEE 802.3 MAC layer 62-1. This multiplexing layer 62-2 may also comprise functionality related to fragmentation and frame loss detection. The base station hub thus interworks the multiplexing layer 62-2 with the AAL5 layer 62-4, which resides on top of the ATM layer 62-3.

FIG. 6d depicts a management plane protocol architecture 63 for the transmission of O&M (i.e. management) messages between the RNC and the base station. These O&M messages may be exchanged between said base station and a management server, but are routed via said RNC. Said O&M messages may for instance at least partially be related to Fault, Configuration, Accounting, Performance and Security Management (FCAPS), and/or to implementation-specific aspects (hardware and software of the base station) and may typically be generated by an O&M server. In the management plane protocol architecture 63, the base station hub uses an IP layer 63-4 to interwork the IEEE 802.3 MAC layer 63-1 and the AAL5 layer 63-3, which resides on ATM layer 63-2.

According to a straightforward approach of the second embodiment of the present invention, the protocol for the transmission of these O&M messages between RNC and base station is not terminated in the base station hub. The base station hub then may generally perform routing on the network layer 64-4. However, if said protocol for the transmission of O&M messages resides on top of IP-based protocol architectures for both the link between RNC and base station hub, and the link between base station hub and base station, also IP tunnelling could be used.

In the second embodiment of the present invention discussed so far, when one or more base stations are connected to a base station hub, the RNC to which said base station hub is connected is aware of each of said base stations and operates as if said base stations were directly connected to the RNC.

However, the second embodiment of the present invention also offers the possibility to concentrate management operations and radio network layer control signalling in the base station hub, so that the RNC then is no longer aware of the individual base stations connected to a base station hub. The base station hub then may for instance terminate the NBAP and control the base station connected to it by itself. Similarly, the base station may terminate protocols related to a management of the base stations by the RNC or a management system. The resulting radio network control plane and management plane protocol architectures are depicted in FIGS. 6e and 6f, respectively.

According to the radio network control plane protocol architecture 64 of FIG. 6e, it is seen that the NBAB protocol 64-1 is terminated in the base station hub, and that the base station hub uses a proprietary protocol 64-2 for the management of its one or more connected base stations instead.

According to the management plane protocol architecture 65 of FIG. 6f, it is seen that the topmost O&M protocol 65-1 of protocol architecture 65 is terminated by the base station hub, and that the base station hub uses a proprietary O&M protocol 65-2 to manage its associated base station(s). The base station hub then may run a management agent that cooperates with a management agent in a O&M server in the UTRAN. Said base station hub then may for instance perform one or all of the following management operations: management of Fault, Configuration, Accounting, Performance and Security Management (FCAPS), and/or implementation-specific management of hardware and software of the base station.

In the protocol architecture 65 of FIG. 6f, it is assumed that these O&M protocols 65-1, 65-2 on both sides of the base station hub are TCP/IP based protocols irrespective of the different underlying physical layer protocols 47, 46.

As the above description of the second embodiment of the present invention has shown, base stations in this embodiment have to support at least AAL2 functionality. Proprietary protocols 64-2, 65-2 may be needed between the base station hub and each base station. The second embodiment allows both for a separate management of each base station, and for a centralized management of one or more base stations connected to the base station hub. The base station hub then may be able to perform a softer handover for a mobile station that is first associated with a first base station and then changes to a second base station (i.e. performs a handover), wherein both base stations are connected to said base station hub. It is then possible to serve said mobile station by both base stations during the handover.

### Third Embodiment

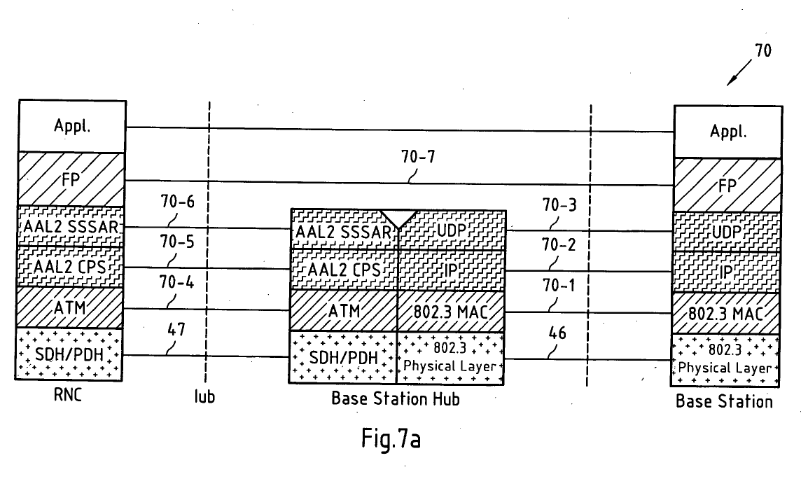

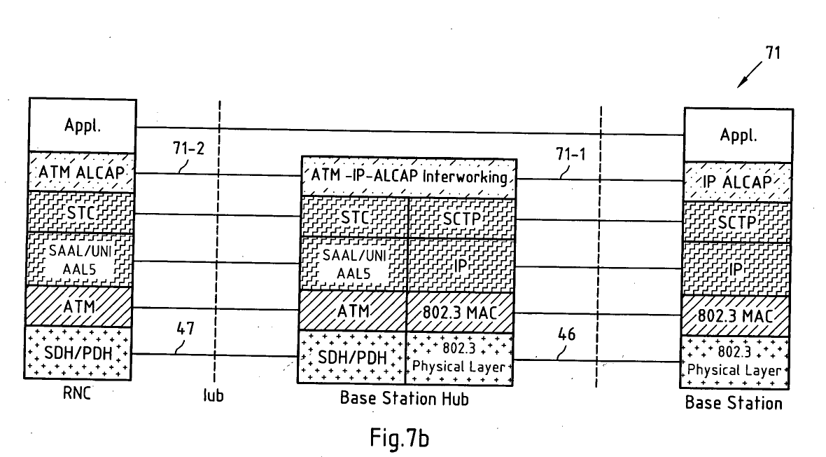

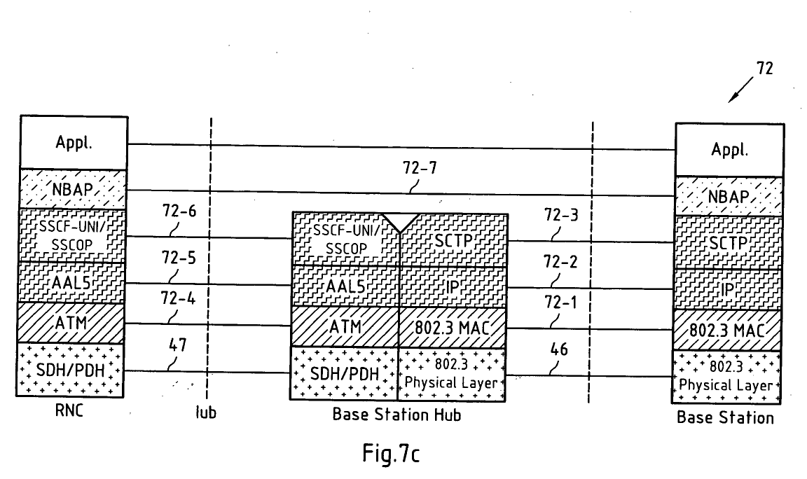

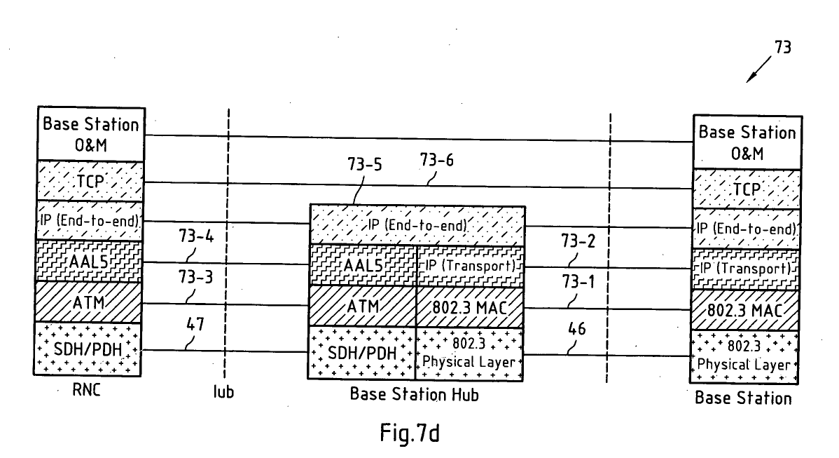

FIG. 7a depicts a user plane protocol architecture 70 for the transmission of data streams 340 (see FIG. 2) over data (or transport) bearers 341 in the user plane 34 of a UTRAN according to the third embodiment of the present invention. In this user plane protocol architecture 70, the FP protocol 70-7 operated between the RNC and the base station is not terminated by the base station hub.

According to this third embodiment of the present invention, the FP frames can be transported on top of a proprietary multiplexing layer that interfaces with the IEEE 802.3 MAC layer 70-1 residing on top of an IEEE 802.3 physical layer protocol 46, or can be transported on top of a UDP/IP protocol architecture 70-2, 70-3, as it is depicted in FIG. 7a. The base station hub then terminates the UDP layer 70-3 towards the base station and the AAL2 SSSAR layer 70-6 towards the RNC. Therein, the AAL2 SSSAR layer 70-6 resides on top of the AAL2 CPS layer 70-5, which in turn resides on top of the ATM layer 70-4. Instead of the UDP/IP layer, also a proprietary multiplexing layer may be used. The base station hub may perform an interworking of the UDP 70-3 and AAL2 SSSAR protocols 70-6 by means of a mapping table, which maps ATM interface parameters, VPIs, VCIs and CIDs to IP addresses and UDP ports. This mapping table may for instance be set up by AAL2/IPC signalling, wherein IPC denotes IP Control.

As concerns the transport network control plane, it can be seen from the transport network control plane protocol architecture 71 of FIG. 7b, that the ALCAP protocol is interworked in the base station hub. Between the RNC and the base station hub, an ATM-based ALCAP 71-2 is used, for instance the Q.2630.2 protocol, and between the base station hub and the base station, an IP-based ALCAP 71-1, for instance the Q.2631.1, is used. The interworking of both ALCAP protocols is basically specified in Q.2631.1 and may be modified and extended to match this special application case. In the protocol architecture 71 of FIG. 7b, optionally the SCTP protocol below the IP-based ALCAP protocol 71-1 could be replaced with TCP and a message wrapper.

FIG. 7c depicts a radio network control plane protocol architecture 72 for the transmission of NBAP 320 messages (see FIG. 2) over signalling bearers 321 in the radio network control plane 32 of a UTRAN according to the third embodiment of the present invention. In this radio network control plane protocol architecture 72, the NBAP protocol 72-7 is not terminated by the base station hub, and the NBAP messages are transported over Ethernet on top of a SCTP/IP protocol 72-2, 72-3 (according to technical specification 3GPP TS 24.432) which resides on top of the IEEE 802.3 MAC protocol 72-1. Optionally, also the SSCF-UNI/SSCOP protocol 72-6 could be terminated in the base station, if TCP/IP was used. In contrast, in the protocol architecture 72 of FIG. 7c, the SSCF-UNI/SSCOP protocol 72-6 is assumed to reside on the AAL5 protocol layer 72-5, which in turn resides on the ATM layer 72-4.

FIG. 7d depicts a management plane protocol architecture 73 for the transmission of O&M messages (originating from an O&M server) between the RNC and the base station. In the management protocol architecture 73 of FIG. 7d, O&M traffic is sent via an end-to-end IP layer 73-5 from the RNC to the base station without terminating an overlying TCP layer 73-6. Routing is performed in the base station hub within said end-to-end layer 73-5. Towards the base station, the end-to-end IP layer 73-5 is tunneled via the transport IP layer 73-2 from base station hub to the base station. This transport IP layer 73-2 resides on top of an IEEE 802.3 MAC layer. On the RNC side of the protocol architecture, the end-to-end IP layer 73-5 resides on top of an AAL5 layer 73-4, which in turn resides on top of an ATM layer 73-3.

Similar to the second embodiment of the present invention, it is also possible to centralize the control and management of one or several base station connected to a base station hub in said base station hub, so that the RNC is not aware how many base stations are connected to said base station hub. This may allow for a more efficient use of resources, a reduced complexity of the base stations, and the possibility to perform softer handover with the base station hub. The management plane protocol architecture for this application case equals the management plane protocol architecture 65 of FIG. 6f.

The third embodiment of the present invention allows for a vast reduction of the complexity of the base station. Basically, the base station only may have to implement UDP or TCP and IP as transport protocols. The transport complexity is moved to the base station hub, which has to support ATM, AAL2 and AAL5, and UDP or TCP and IP to allow for appropriate interworking. For the transport network control plane, substantially an IP ALCAP can be used. By installing a management agent or proxy in the base station hub, so that all base stations connected to a base station hub may be seen as one base station by the RNC.

The invention has been described above by means of exemplary embodiments. It should be noted that there are alternative ways and variations which are obvious to a skilled person in the art and can be implemented without deviating from the scope and spirit of the appended claims. In particular, the present invention is not restricted to application in a UTRAN only, it may equally well be deployed in any other type of radio system where a base station is connected to some type of base station controller. Furthermore, the present invention is not limited to Ethernet as first-type physical layer protocol. Instead, all other types of physical layer protocols can be imagined to connect the at least one base station to the base station hub, for instance wireless links or optical links.

1. A method for data transmission between at least one base station and a radio network controller in a radio access network, said method comprising:
operating a first-type physical layer protocol for a transmission of said data between said at least one base station and a base station hub; and
operating a second-type physical layer protocol for a transmission of said data between said base station hub and said radio network controller;
wherein said data comprises user data that is transmitted between said radio network controller and said at least one base station via said base station hub, and wherein said at least one base station performs at least base band processing for signals that are transmitted via a radio interface and represent said user data.

2. The method according to claim 1, wherein said data further comprises control data that is transmitted between said at least one base station and said radio network controller via said base station hub to perform control signalling in at least one of a radio network layer and a transport network layer of said radio access network.

3. The method according to claim 1, wherein said data further comprises management data related to a management of said at least one base station.

4. The method according to claim 1, wherein said first-type physical layer protocol is an IEEE 802 physical layer protocol.

5. The method according to claim 1, wherein said first-type physical layer protocol is an IEEE 802.3 physical layer protocol.

6. The method according to claim 1, wherein said second-type physical layer protocol represents one of a Synchronous and a Plesiochronous Digital Hierarchy link.

7. The method according to claim 1, wherein said radio access network is a Universal Mobile Telecommunications System Terrestrial Radio Access Network.

8. The method according to claim 1, wherein said data is transmitted between a plurality of base stations and said radio network controller, and wherein said base station hub operates said first-type physical layer protocol for a transmission of said data between said base station hub and said plurality of base stations.

9. The method according to claim 1, wherein said base station hub provides synchronization information to said at least one base station.

10. The method according to claim 1, further comprising:
interworking said second-type physical layer protocol and a first protocol, which is operated between said base station hub and said at least one base station for a transmission of said data on top of said first-type physical layer protocol, in said base station hub while not terminating a second protocol that is operated between said at least one base station and said radio network controller for a transmission of said data on top of said second-type physical layer protocol and said first protocol.

11. The method according to claim 10, wherein said first-type physical layer protocol is an IEEE 802 physical layer protocol, wherein said second-type physical layer protocol represents one of a Synchronous and a Plesiochronous Digital Hierarchy link, and wherein said first protocol is an IEEE 802 MAC protocol.

12. The method according to claim 10, wherein said second protocol is an Asynchronous Transfer Mode protocol.

13. The method according to claim 12, wherein said base station hub is an ATM cross-connect.

14. The method according to claim 1, further comprising:
interworking said second-type physical layer protocol and said first-type physical layer protocol in said base station hub while not terminating a protocol that is operated between said at least one base station and said radio network controller for a transmission of said data on top of said first-type physical layer protocol and said second-type physical layer protocol.

15. The method according to claim 1, further comprising:
operating an ATM protocol) for a transmission of said data between said at least one base station and said radio network controller, wherein said ATM protocol is not terminated by said base station hub.

16. The method according to claim 10, wherein parameters required for said interworking in said base station hub are defined by an operator of said radio access network during network configuration.

17. The method according to claim 10, wherein parameters required for said interworking in said base station hub are defined by a proprietary protocol that is operated between said at least one base station and said base station hub.

18. The method according to claim 1, further comprising:
operating a first protocol for a transmission of said user data between said at least one base station and said base station hub on top of said first-type physical layer protocol and a second protocol for a transmission of said user data between said at least one base station and said base station hub on top of said first protocol;
operating a third protocol for a transmission of said user data between said base station hub and said radio network controller on top of said second-type physical layer protocol; and
interworking said second and said third protocol in said base station hub while not terminating a fourth protocol that is operated between said at least one base station and said radio network controller for a transmission of said user data on top of said second and said third protocol.

19. The method according to claim 18, wherein said first protocol is an IEEE 802 MAC protocol, said third protocol is an ATM protocol, and said fourth protocol is an AAL2 CPS protocol.

20. The method according to claim 18, wherein said second protocol is a proprietary protocol.

21. The method according to claim 18, wherein said second protocol represents a combination of a UDP protocol and an underlying IP protocol.

22. The method according to claim 1, further comprising:
operating a first protocol for a transmission of said user data between said at least one base station and said base station hub on top of said first-type physical layer protocol;
operating a second protocol for a transmission of said user data between said base station hub and said radio network controller on top of said second-type physical layer protocol, and
interworking said first and said second protocol in said base station hub while not terminating a third protocol that is operated between said at least one base station and said radio network controller for a transmission of said user data on top of said second and said third protocol.

23. The method according to claim 1, further comprising: operating an AAL2 protocol for a transmission of said user data between said at least one base station and said radio network controller, wherein said AAL2 protocol is not terminated by said base station hub.

24. The method according to claim 18, wherein said data that is transmitted between said at least one base station and said radio network controller via said base station hub further comprises transport network control data related to a control signalling in a transport network layer of said radio access network, wherein said control signalling is performed by a first-type control protocol that is operated between said at least one base station and said base station hub, and a second-type control protocol that is operated between said base station hub and said radio network controller, and wherein in said base station hub, an interworking of said first-type control protocol and second-type control protocol is performed.

25. The method according to claim 24, wherein said second-type control protocol is an ALCAP protocol.

26. The method according to claim 18, wherein said data that is transmitted between said at least one base station and said radio network controller via said base station hub further comprises radio network control data related to a control signalling in a radio network layer of said radio access network, said method further comprising:
operating a fifth protocol for a transmission of said radio network control data between said at least one base station and said base station hub on top of said first-type physical layer protocol and a sixth protocol for a transmission of said radio network control data between said at least one base station and said base station hub on top of said fifth protocol;
operating a seventh protocol for a transmission of said radio network control data between said base station hub and said radio network controller on top of said second-type physical layer protocol and an eighth protocol for a transmission of said radio network control data between said base station hub and said radio network controller on top of said seventh protocol;
interworking said sixth protocol and said eighth protocol in said base station hub while not terminating a ninth protocol that is operated between said at least one base station and said radio network controller for a transmission of said radio network control data on top of said sixth protocol) and said eighth protocol.

27. The method according to claim 26, wherein said fifth protocol is an IEEE 802 MAC protocol, said sixth protocol is a multiplexing protocol, said seventh protocol is an ATM protocol, said eighth protocol is an AAL5 protocol, and said ninth protocol is an SSCF-UNI protocol on top of an SSCOP protocol.

28. The method according to claim 18, wherein said data that is transmitted between said at least one base station and said radio network controller via said base station hub further comprises radio network control data related to a control signalling in a radio network layer of said radio access network, said method further comprising:
operating an SSCF-UNI protocol on top of an SSCOP protocol for a transmission of said user data between said at least one base station and said radio network controller, wherein said SSCF-UNI and said SSCOP protocols are not terminated by said base station hub.

29. The method according to claim 18, wherein at least one protocol related to a control signalling between said at least one base station and said radio network controller in a radio network layer of said radio access network is terminated in said base station hub, and wherein said base station hub performs said control signalling for said at least one base station.

30. The method according to claim 29, wherein said at least one protocol is an NBAP protocol.

31. The method according to claim 18, wherein said data that is transmitted between said at least one base station and said radio network controller via said base station hub further comprises management data related to a management of said at least one base station, said method further comprising:
operating a fifth protocol for a transmission of said management data between said at least one base station and said base station hub on top of said first-type physical layer protocol;
operating a sixth protocol for a transmission of said management data between said base station hub and said radio network controller on top of said second-type physical layer protocol and a seventh protocol for a transmission of said management data between said base station hub and said radio network controller on top of said sixth protocol;
interworking said fifth protocol and said seventh protocol in said base station hub by an eighth protocol operated on top of said fifth protocol and said seventh protocol while not terminating a ninth protocol that is operated between said at least one base station and said radio network controller for a transmission of said management data on top of said eighth protocol.

32. The method according to claim 31, wherein said fifth protocol is an IEEE 802 MAC protocol, said sixth protocol is an ATM protocol, said seventh protocol is an AAL5 protocol, said eighth protocol is an IP protocol, and said ninth protocol is a TCP protocol.

33. The method according to claim 1, further comprising:
operating a first protocol for a transmission of said user data between said at least one base station and said base station hub on top of said first-type physical layer protocol; a second protocol for a transmission of said user data between said at least one base station and said base station hub on top of said first protocol; and a third protocol for a transmission of said user data between said at least one base station and said base station hub on top of said second protocol;
operating a fourth protocol for a transmission of said user data between said base station hub and said radio network controller on top of said second-type physical layer protocol; a fifth protocol for a transmission of said user data between said base station hub and said radio network controller on top of said fourth protocol; and a sixth protocol for a transmission of said user data between said base station hub and said radio network controller on top of said fifth protocol; and
interworking said third and said sixth protocol in said base station hub while not terminating a seventh protocol that is operated between said at least one base station and said radio network controller for a transmission of said user data on top of said third and said sixth protocol.

34. The method according to claim 33, wherein said first protocol is an IEEE 802 MAC protocol, said second protocol is an IP protocol, and said third protocol is a UDP protocol, said fourth protocol is an ATM protocol, said fifth protocol is an AAL2 CPS protocol, said sixth protocol is an AAL2 SSSAR protocol, and said seventh protocol is an FP protocol.

35. The method according to claim 33, wherein, instead of said second and said third protocol, an eighth protocol for a transmission of said user data is operated between said at least one base station and said base station hub on top of said first protocol; wherein said seventh protocol is operated between said at least one base station and said radio network controller for a transmission of said user data on top of said eighth and sixth protocol; and wherein said eighth and sixth protocol are interworked in said base station hub while not terminating said seventh protocol.

36. The method according to claim 35, wherein said eighth protocol is a multiplexing protocol.

37. The method according to claim 1, further comprising:
operating an FP protocol for a transmission of said user data between said at least one base station and said radio network controller, wherein said FP protocol is not terminated by said base station hub.

38. The method according to claim 33, wherein said data that is transmitted between said at least one base station and said radio network controller via said base station hub further comprises transport network control data related to a control signalling in a transport network layer of said radio access network, wherein said control signalling is performed by a first-type control protocol that is operated between said at least one base station and said base station hub, and a second-type control protocol that is operated between said base station hub and said radio network controller, and wherein, in said base station hub, an interworking of said first-type and second-type control protocol is performed.

39. The method according to claim 38, wherein said first-type control protocol is an IP-based ALCAP protocol, and wherein said second-type control protocol is an ATM-based ALCAP protocol.

40. The method according to claim 33, wherein said data that is transmitted between said at least one base station and said radio network controller via said base station hub further comprises radio network control data related to a control signalling in a radio network layer of said radio access network, said method further comprising:
operating an eighth protocol for a transmission of said radio network control data between said at least one base station and said base station hub on top of said first-type physical layer protocol; a ninth protocol for a transmission of said radio network control data between said at least one base station and said base station hub on top of said eighth protocol; and a tenth protocol for a transmission of said radio network control data between said at least one base station and said base station hub on top of said ninth protocol;
operating an eleventh protocol for a transmission of said radio network control data between said base station hub and said radio network controller on top of said second-type physical layer protocol, a twelfth protocol for a transmission of said radio network control data between said base station hub and said radio network controller on top of said eleventh protocol, and a thirteenth protocol for a transmission of said radio network control data between said base station hub and said radio network controller on top of said twelfth protocol; and
interworking said tenth protocol and said thirteenth protocol in said base station hub while not terminating a fourteenth protocol that is operated between said at least one base station and said radio network controller for a transmission of said radio network control data on top of said tenth protocol and said thirteenth protocol.

41. The method according to claim 40, wherein said eighth protocol is an IEEE 802 MAC protocol, said ninth protocol is an IP protocol, said tenth protocol is an SCTP protocol, said eleventh protocol is an ATM protocol, said twelfth protocol is an AAL5 protocol, said thirteenth protocol is an SSCF-UNI protocol on top of an SSCOP protocol, and said fourteenth protocol is an NBAP protocol.

42. The method according to claim 33, wherein said data that is transmitted between said at least one base station and said radio network controller via said base station hub further comprises radio network control data related to a control signalling in a radio network layer of said radio access network, said method further comprising:
operating a protocol for a transmission of said radio network control data between said at least one base station and said radio network controller, wherein said protocol is not terminated by said base station hub.

43. The method according to claim 42, wherein said protocol is an NBAP protocol.

44. The method according to claim 33, wherein said data that is transmitted between said at least one base station and said radio network controller via said base station hub further comprises management data related to a management of said at least one base station, said method further comprising:
operating an eighth protocol for a transmission of said management data between said at least one base station and said base station hub on top of said first-type physical layer protocol and a ninth protocol for a transmission of said management data between said at least one base station and said base station hub on top of said eighth protocol;
operating a tenth protocol for a transmission of said management data between said base station hub and said radio network controller on top of said second-type physical layer protocol and an eleventh protocol for a transmission of said management data between said base station hub and said radio network controller on top of said tenth protocol;
interworking said ninth protocol and said eleventh protocol in said base station hub by a twelfth protocol operated on top of said ninth protocol and said eleventh protocol while not terminating a thirteenth protocol that is operated between said at least one base station and said radio network controller for a transmission of said management data on top of said twelfth protocol.

45. The method according to claim 44, wherein said eighth protocol is an IEEE 802 MAC protocol, said ninth protocol is an IP protocol, said tenth protocol is an ATM protocol, said eleventh protocol is an AAL5 protocol, said twelfth protocol is an end-to-end IP protocol and said thirteenth protocol is a TCP protocol.

46. The method according to claim 1, wherein a management unit uses a first-type management protocol to cause said at least one base station to perform management-related operations, and wherein at least one of said management-related operations is performed by said base station hub instead of said at least one base station.

47. The method according to claim 46, wherein said management-related operations comprise at least one of fault handling operations, configuration operations, accounting operations, performance measurement operations, security operations, software management operations, hardware management operations, operations related to an aggregation of alarms and operations related to a filtering of alarms.

48. The method according to claim 47, wherein said base station hub terminates said first-type management protocol towards said management unit and operates a second-type management protocol with said at least one base station.

49. The method according to claim 48, wherein said second-type management protocol is an IP-based protocol.

50. The method according to claim 46, wherein said data is transmitted between a plurality of base stations and said radio network controller, and wherein said base station hub operates said first-type physical layer protocol for a transmission of said data between said base station hub and said plurality of base stations.

51. The method according to claim 50, wherein said radio network controller considers said base station hub and said plurality of base stations as a single base station.

52. The method according to claim 50, wherein said base station hub supports a softer handover.

53. A system for data transmission in a radio access network, said system comprising:
a radio network controller;
a base station hub; and
at least one base station;
wherein said base station hub and said at least one base station comprise means for operating a first-type physical layer protocol for a transmission of said data between said at least one base station and the base station hub, wherein said base station hub and said radio network controller comprise means for operating a second-type physical layer protocol for a transmission of said data between said base station hub and said radio network controller, wherein said data comprises user data that is transmitted between said radio network controller and said at least one base station via said base station hub, and wherein said at least one base station comprises means for performing at least base band processing for signals that are transmitted via a radio interface and represent said user data.

54. A base station for data transmission in a radio access network, said base station comprising:
means for operating a first-type physical layer protocol for a transmission of data between said base station and a base station hub, wherein said data is transmitted between said base station hub and a radio network controller according to a second-physical layer protocol, and wherein said data comprises user data that is transmitted between said radio network controller and at least one base station via said base station hub; and
means for performing at least base band processing for signals that are transmitted via a radio interface and represent said user data.

55. A software application executable in a base station in a radio access network, said software application comprising:
program code for causing said base station to operate a first-type physical layer protocol for a transmission of data between said base station and a base station hub, wherein said data is transmitted between said base station hub and a radio network controller according to a second-physical layer protocol, and wherein said data comprises user data that is transmitted between said radio network controller and at least one base station via said base station hub; and
program code for causing said base station to perform at least base band processing for signals that are transmitted via a radio interface and represent said user data.

56. A base station hub for data transmission in a radio access network, said base station hub comprising:
means for operating a first-type physical layer protocol for a transmission of data between at least one base station and said base station hub; and
means for operating a second-type physical layer protocol for a transmission of said data between said base station hub and a radio network controller;
wherein said data comprises user data that is transmitted between said radio network controller and said at least one base station via said base station hub; and wherein said at least one base station performs at least base band processing for signals that are transmitted via a radio interface and represent said user data.

57. A software application executable in a base station hub in a radio access network, said software application comprising:
program code for causing said base station hub to operate a first-type physical layer protocol for a transmission of data between at least one base station and said base station hub; and
program code for causing said base station hub to operate a second-type physical layer protocol for a transmission of said data between said base station hub and a radio network controller;
wherein said data comprises user data that is transmitted between said radio network controller and said at least one base station via said base station hub; and wherein said at least one base station performs at least base band processing for signals that are transmitted via a radio interface and represent said user data.
